(19) United States
(12) Patent Application Publication
(10) Pub. No.: US 2019/0373513 A1
(43) Pub. Date: Dec. 5, 2019

(54) DISTRIBUTED UNIT AND CENTRALIZED UNIT OF A BASE STATION

(71) Applicant: Institute For Information Industry, Taipei (TW)

(72) Inventor: Chiu-Wen CHEN, Taipei City (TW)

(21) Appl. No.: 16/427,722

(22) Filed: May 31, 2019

Related U.S. Application Data
(60) Provisional application No. 62/678,282, filed on May 31, 2018.

(51) Int. Cl. H04W 28/26

(52) U.S. Cl. CPC H04W 28/26

(57) ABSTRACT

A distributed unit and a centralized unit of a base station are provided. The distributed unit receives an RRC connection request message from a user equipment. In response to the RRC connection request message, the distributed unit transmits a base station end (BS-end) connection request message to the control unit, wherein the BS-end connection request message carries a first application protocol identity and a first RRC message. The first RRC message is the RRC connection request message. The control unit transmits a BS-end connection determination message to the distributed unit, wherein the BS-end connection determination message carries the first application protocol identity, a second application protocol identity, a second RRC message, and a piece of SRB information. The distributed unit retrieves the second RRC message from the BS-end connection determination message and transmits the second RRC message to the user equipment.

### PRIORITY

This application claims priority to US Provisional Patent Application No. 62/678,282 filed on May 31, 2018, which is hereby incorporated by reference in its entirety.

### FIELD

The present invention relates to a distributed unit (DU) and a centralized unit (CU) of a base station. More particularly, the present invention relates to a distributed unit and a centralized unit which are able to respond to various Radio Resource Control (RRC) requests from a user equipment.

### BACKGROUND

Currently, research and development personnel and mobile communication companies around the world are actively developing specifications of the fifth generation (5G) mobile communication system. According to the updated specification, a base station of the 5G mobile communication system adopts a radio access network (RAN) functional split, that is, a base station contains a centralized unit and at least one distributed unit as shown in FIG. 1A. The centralized unit and the distributed unit(s) may each be an individual hardware device or may be integrated into a same hardware device.

Under the RAN functional split, the centralized unit performs the upper several layers of a communication protocol stack, and each distributed unit performs the lower several layers of the same communication protocol stack. Taking the second option (option 2) of the RAN functional split of the 5G mobile communication system as an example, the centralized unit performs the RRC layer, the service data adaptation protocol (SDAP) layer, and the packet data convergence protocol (PDCP) layer, and each distributed unit individually performs the radio link control (RLC) layer, the media access control (MAC) layer, and the physical (PHY) layer as shown in FIG. 1B. In addition, the centralized unit communicates with each distributed unit through a logical interface called F1 interface as shown in FIG. 1B.

According to most current mobile communication systems (e.g., the widely-used Long Term Evolution (LTE) communication system), a user equipment has to establish a radio connection with the base station first before connecting to the Internet. FIG. 1C and FIG. 1D respectively illustrate a schematic view of message transmission of a conventional base station accepting and rejecting a radio connection request of a user equipment. The user equipment can only use a specific signal radio bearer (hereinafter referred to as “SRB”) (in the case of the LTE communication system, it is SRB0) before the radio connection is established. The user equipment starts from transmitting an RRC connection request message to the base station via the specific SRB. If the base station accepts the user equipment's request for establishing a radio connection, the base station will transmit an RRC connection setup message to the user equipment via the specific SRB and then the user equipment will transmit an RRC connection setup complete message to the base station via another specific SRB (in the case of the LTE communication system, it is SRB1) as shown in FIG. 1C. If the base station rejects the request of the user equipment for establishing a radio connection, the base station will transmit an RRC connection reject message to the user equipment via the same specific SRB as shown in FIG. 1D. In other words, whether the base station accepts the user equipment's request for establishing a radio connection means whether the base station agrees the user equipment to activate another specific SRB for use (take the LTE communication system as an example, it means whether the base station agrees the user equipment to activate SRB1 for use).

Since the 5G mobile communication system adopts the RAN functional split, messages transmitted to the base station by the user equipment is first received by a distributed unit and then transmitted to the centralized unit by the distributed unit. If the user equipment transmits an RRC connection related message (e.g., an RRC connection request message and an RRC connection re-establishment request message), the distributed unit will not be able to decode the RRC connection related message because the communication protocol stack performed by the distributed unit does not comprise the RRC layer. Therefore, how to make a distributed unit and a centralized unit cooperate with each other to respond to various RRC connection related messages transmitted by the user equipment is a technical problem that needs to be solved in the 5G mobile communication system.

### SUMMARY

To solve at least the aforesaid problem, provided are a distributed unit of a base station and a centralized unit of a base station.

The distributed unit in certain embodiments can be adapted to a base station, wherein the base station comprises the distributed unit and a centralized unit. The distributed unit can comprise a first transceiving interface, a second transceiving interface, and a processor, and the processor is electrically connected to the first transceiving interface and the second transceiving interface. The second transceiving interface is configured to receive a Radio Resource Control (RRC) connection request message from a user equipment. The processor is configured to generate a base station end (BS-end) connection request message in response to the RRC connection request message, wherein the BS-end connection request message carries a first application protocol identity and a first RRC message. The first application protocol identity is configured to uniquely identify the user equipment over the first transceiving interface within the distributed unit. The first RRC message is the RRC connection request message. The first transceiving interface further transmits the BS-end connection request message to the centralized unit and receives a BS-end connection determination message from the centralized unit. The BS-end connection determination message carries the first application protocol identity, a second application protocol identity, a second RRC message, and a piece of first Signaling Radio Bearer (SRB) information. The second application protocol identity is configured to uniquely identify the user equipment over the first transceiving interface within the centralized unit. The processor further retrieves the second RRC message from the BS-end connection determination message, and the second transceiving interface further transmits the second RRC message to the user equipment.

The centralized unit in certain embodiments can be adapted to a base station, wherein the base station comprises the centralized unit and a distributed unit. The centralized unit comprises a transceiving interface and a processor, wherein the transceiving interface and the processor are electrically connected to each other. The transceiving interface is configured to receive a BS-end connection request message, wherein the BS-end connection request message carries a first application protocol identity and a first RRC message. The first application protocol identity is configured to uniquely identify the user equipment over the transceiving interface within the distributed unit. The processor is configured to determine that the first RRC message is an RRC connection request message by decoding the BS-end connection request message. The processor is configured to generate a BS-end connection determination message in response to the RRC connection request message, wherein the BS-end connection determination message carries the first application protocol identity, a second application protocol identity, a second RRC message, and a piece of SRB information. The second application protocol identity is configured to uniquely identify the user equipment over the transceiving interface within the centralized unit. The transceiving interface further transmits the BS-end connection determination message to the distributed unit.

The distributed unit and the centralized unit may be used together as a base station. After the distributed unit receives the RRC connection request message from the user equipment, the distributed unit does not have to decode the RRC connection request message. Instead, the distributed unit encapsulates the RRC connection request message into a BS-end connection request message and then transmit the BS-end request message to the centralized unit. After the centralized unit receives the BS-end connection request message, the centralized unit decodes the BS-end connection request message and, thus, learns that the user equipment has sent the RRC connection request.

In response to the RRC connection request of the user equipment, the centralized unit further encapsulates an RRC message (which may be an RRC connection setup message or an RRC connection reject message) and a piece of SRB information into a BS-end connection determination message and transmits the BS-end connection determination message to the distributed unit. After receiving the BS-end connection determination message, the distributed unit does not decode the RRC message carried in the BS-end connection determination message, but transfer the RRC message to the user equipment instead. Through the aforesaid operation process, although the communication protocol stack performed by the distributed unit does not comprise the RRC layer and cannot understand the actual meaning of the RRC connection related message, the distributed unit can still respond to the RRC connection request of the user equipment by cooperating with the centralized unit. Therefore, the distributed unit and the centralized unit provided by the present invention have solved the aforesaid technical problems faced by the 5G mobile communication system.

The detailed technologies and embodiments of the present invention are described in the following description in conjunction with the drawings, and the technical features of the claimed invention may be understood by a person having ordinary skill in the art.

### BRIEF DESCRIPTION OF THE DRAWINGS

FIG. 1A illustrates the architecture of the RAN functional split employed by a base station of a 5G mobile communication system.

FIG. 1B illustrates a network communication protocol performed by a centralized unit and a distributed unit of a base station of a 5G mobile communication system.

FIG. 1C illustrates a schematic view of message transmission of a conventional base station accepting a radio connection request from a user equipment.

FIG. 1D illustrates a schematic view of message transmission of a conventional base station rejecting a radio connection request from a user equipment.

FIG. 2 illustrates a schematic view of the architecture of a mobile communication system 2 according to some embodiments of the present invention.

FIG. 3 illustrates a schematic view of message transmission according to the first embodiment of the present invention.

FIG. 4A illustrates a schematic view of the message transmission for accepting the RRC connection request of the user equipment 21 according to the second and the third embodiments of the present invention.

FIG. 4B illustrates a schematic view of the message transmission for rejecting the RRC connection request of the user equipment 21 according to the second embodiment of the present invention.

FIG. 5 illustrates a schematic view of the message transmission for rejecting the RRC connection request of the user equipment 21 according to the third embodiment of the present invention.

FIG. 6 illustrates a schematic view of the message transmission according to the fourth embodiment of the present invention.

FIG. 7 illustrates a schematic view of the message transmission according to the fifth embodiment of the present invention.

FIG. 8 illustrates a schematic view of the message transmission according to the sixth embodiment of the present invention.

FIG. 9 illustrates a schematic view of the message transmission according to the seventh embodiment of the present invention.

FIG. 10A and FIG. 10B illustrate schematic views of the message transmission according to the eighth embodiment of the present invention.

FIG. 11 illustrates a schematic view of the message transmission according to the ninth embodiment of the present invention.

FIG. 12 illustrates a schematic view of the message transmission according to the tenth embodiment of the present invention.

FIG. 13 illustrates a schematic view of the architecture of a mobile communication system 3 according to some embodiments of the present invention.

FIG. 14 illustrates a schematic view of the message transmission according to the eleventh embodiment of the present invention.

FIG. 15 illustrates a schematic view of the message transmission according to the twelfth embodiment of the present invention.

FIG. 16 illustrates a schematic view of the message transmission according to the thirteenth embodiment of the present invention.

FIG. 17 illustrates a schematic view of the message transmission according to the fourteenth embodiment of the present invention.

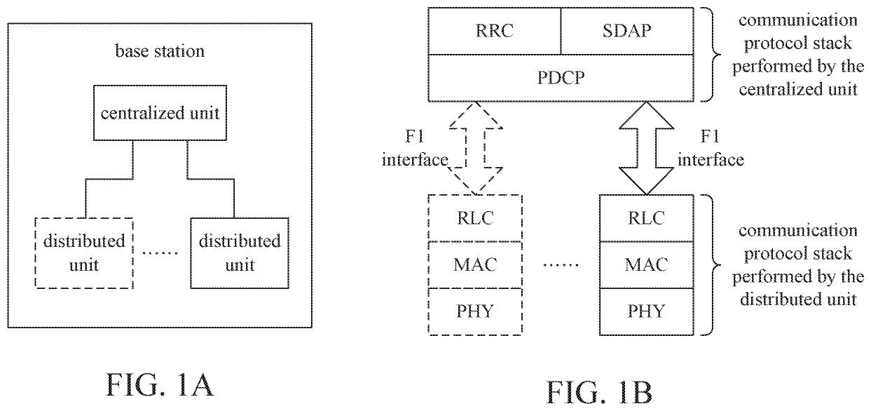

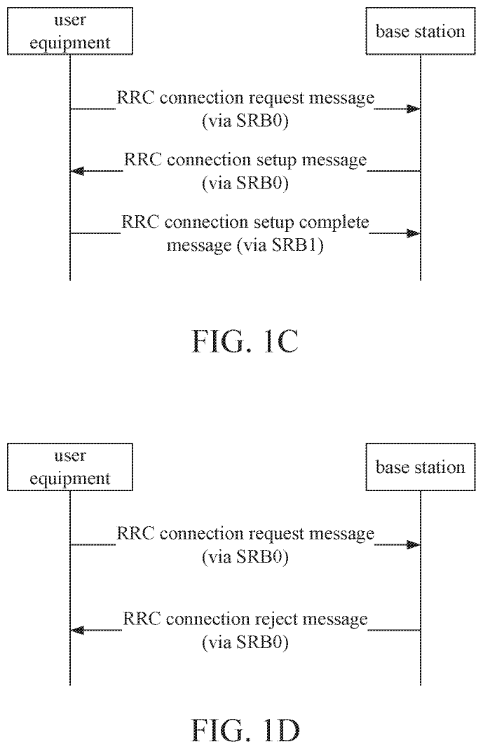

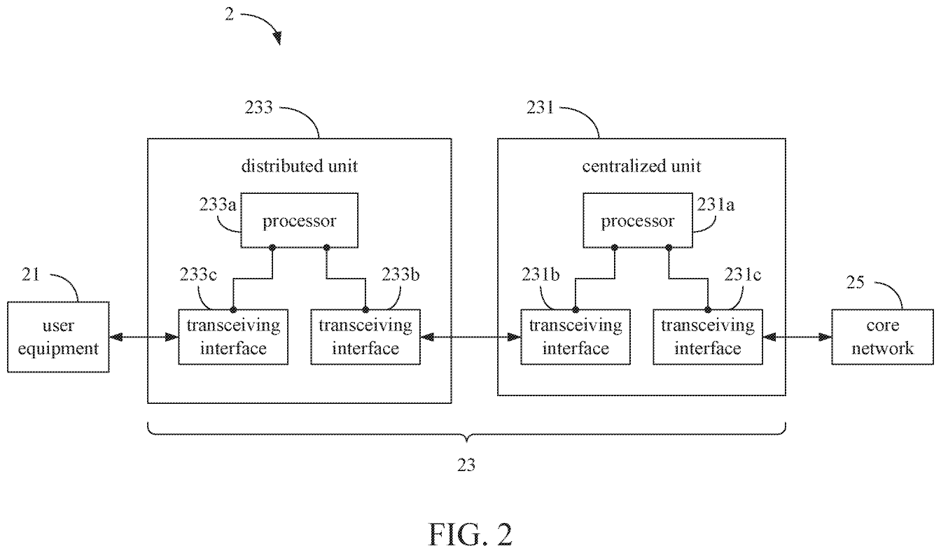

### DETAILED DESCRIPTION

In the following description, the distributed unit of the base station and the centralized unit of the base station will be explained with reference to various example embodiments. However, the example embodiments described hereinafter are not intended to limit the present invention to any specific example, embodiment, environments, applications, or specific process flows or steps described in these example embodiments. The scope of the present invention should be determined according to the Claims. It should be understood that, in the following embodiments and the drawings, the components that are not directly related to the present invention are omitted, and the dimensions of the components and the ratios of the dimensions between the components are merely illustrative and are not intended to limit the scope of the present invention.

FIG. 2 illustrates a schematic view of the architecture of a mobile communication system 2 applies to some embodiments of the present invention. The mobile communication system 2 conforms to the specifications of the 5G mobile communication system and comprises a user equipment 21, a base station 23 (according to the specifications of the 5G mobile communication system, the base station may also be called a gNodeB or a gNB), and a core network 25. The base station 23 adopts the RAN functional split. Specifically, the base station 23 comprises the centralized unit 231 and the distributed unit 233, wherein the centralized unit 231 performs the upper several layers of a communication protocol stack, and the distributed unit 233 performs the lower several layers of the communication protocol stack. If the base station 23 follows the second option of the RAN functional split of the 5G mobile communication system (but not limited thereto), the centralized unit 231 performs the RRC layer, the SDAP layer, and the PDCP layer of the communication protocol stack, and the distributed unit 233 performs the RLC layer, the MAC layer, and the PHY layer of the communication protocol stack. In some embodiments, the centralized unit 231 and the distributed unit 233 may each be an individual hardware device. In some other embodiments, the centralized unit 231 and the distributed unit 233 may be integrated into the same hardware device.

The centralized unit 231 comprises a processor 231a and two transceiving interfaces 231b and 231c, wherein the processor 231a is electrically connected to the transceiving interfaces 231b and 231c. The processor 231a may be one of a variety of processing units, central processing units (CPU), microprocessors, digital signal processors (DSP), or any other computing devices with similar functions known by a person having ordinary skills in the art. The transceiving interface 231b may be any wired or wireless interface capable of communicating with a distributed unit, and the transceiving interface 231c may be any wired or wireless interface capable of communicating with the core network 25. The distributed unit 233 comprises a processor 233a and two transceiving interfaces 233b and 233c, wherein the processor 233a is electrically connected to the transceiving interfaces 233b and 233c. The processor 233a may be one of a variety of processing units, central processing units, microprocessors, digital signal processors, or any other computing device with similar function known by a person having ordinary skills in the art. The transceiving interface 233b may be any wired or wireless interface capable of communicating with a centralized unit, and the transceiving interface 233c may be any wired or wireless interface capable of communicating with a user equipment.

In the embodiments adopting the architecture of the mobile communication system 2, a logical interface (in the 5G mobile communication system, it is called a Next Generation (NG) interface) is established between the centralized unit 231 and the core network 25, and the messages between the centralized unit 231 and the core network 25 are transmitted via the logical interface and by the physical transceiving interface 231c. In addition, a logical interface (in the 5G mobile communication system, it is called an Fl interface) is established between the distributed unit 233 and the centralized unit 231, and the messages between the distributed unit 233 and the centralized unit 231 are transmitted via the logical interface and by the physical transceiving interface 233b and transceiving interface 231b.

A message related to the user equipment 21 has to carry a first application protocol identity (not shown) in order to be transmitted by the distributed unit 233 to the centralized unit 231. The first application protocol identity is configured to uniquely identify the user equipment 21 over the logical interface (over the physical transceiving interface 233b and transceiving interface 231b) within the distributed unit 233. For example, the distributed unit 233 may concatenate its own identity and a temporary cell radio network temporary identifier (tc-RNTI) as the first application protocol identity. It should be understood that the present invention does not limit the actual content of the first application protocol identity as long as the aforesaid identification can be achieved. In some embodiments, the distributed unit 233 may adopt the gNB-DU UE F1AP ID parameter in the 5G mobile communication system as the first application protocol identity.

A message related to the user equipment 21 has to carry a second application protocol identity (not shown) in order to be transmitted by the centralized unit 231 to the distributed unit 233. The second application protocol identity is configured to uniquely identify the user equipment 21 over the logical interface (over the physical transceiving interface 233b and transceiving interface 231b) within the centralized unit 231. For example, the centralized unit 231 may concatenate a New Radio Cell Global Identity (NR CGI) and a 5G SAE-Temporary Mobile Subscriber Identity (5G-S-TMSI) as the second application protocol identity. It should be understood that the present invention does not limit the actual content of the second application protocol identity as long as the aforesaid identification may be achieved. In some embodiments, the centralized unit 231 may adopt the gNB-CU UE F1AP ID parameter in the 5G mobile communication system as the second application protocol identity.

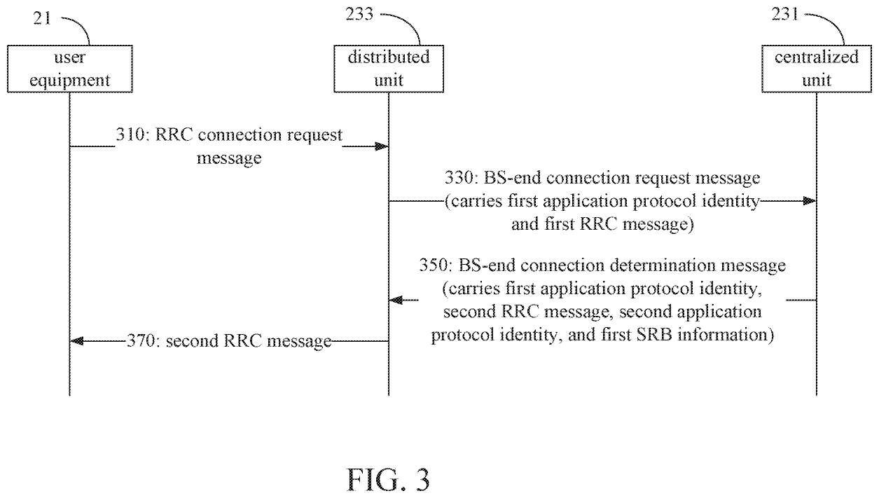

Please refer to FIG. 3, which illustrates a schematic view of message transmission according to the first embodiment of the present invention. In this embodiment, in response to the RRC connection request of the user equipment 21, the base station 23 internally adopts a 2-way handshaking process (i.e., the BS-end connection request message 330 and the BS-end connection determination message 350 shown in FIG. 3).

Specifically, the user equipment 21 request the base station 23 for an RRC connection by transmitting an RRC connection request message 310 to the base station 23 through an uplink common control channel (UL-CCCH), and the RRC connection request message 310 is received by the transceiving interface 233c of the distributed unit 233 via the uplink common control channel. Since the distributed unit 233 receives the RRC connection request message 310 via the uplink common control channel, the distributed unit 233 is able to learn that the RRC connection request message 310 is an RRC related message without decoding the RRC connection request message 310.

In response to receiving an RRC related message (i.e., the RRC connection request message 310), the processor 233a of the distributed unit 233 generates a BS-end connection request message 330, and the transceiving interface 233b further transmits the BS-end connection request message 330 to the centralized unit 231. It should be noted that the BS-end connection request message 330 carries a first application protocol identity and a first RRC message, wherein the first RRC message is the RRC connection request message 310 received by the distributed unit 233. In other words, the distributed unit 233 encapsulates the received RRC connection request message 310 into the BS-end connection request message 330. In an embodiment, the BS-end connection request message 330 comprises an RRC container, and the first RRC message is carried in the information element of the uplink common control channel comprised in the information element of the RRC container.

Next, the transceiving interface 231b of the centralized unit 231 receives the BS-end connection request message 330, and the processor 231a determines that the BS-end connection request message 330 carries the RRC connection request message by decoding the BS-end connection request message 330 (i.e., determines that the BS-end connection request message 330 carries a first RRC message, and determines that the first RRC message is an RRC connection request message after decoding the first RRC message). In an embodiment, the processor 231a retrieves the first RRC message from the information element of the uplink common control channel comprised in the information element of the RRC container comprised in the BS-end connection request message 330, and determines that the first RRC message is an RRC connection request message.

In response to receiving the RRC connection request message, the processor 231a of the centralized unit 231 generates a BS-end connection determination message 350, and then the transceiving interface 231b transmits the BS-end connection determination message 350 to the distributed unit 233. It should be noted that the BS-end connection determination message 350 carries the first application protocol identity, the second application protocol identity, a second RRC message, and a piece of first SRB information. Depending on different situations (for example, whether the base station 23 has sufficient radio resources to serve a user equipment), the second RRC message may be an RRC connection setup message or an RRC connection reject message. In addition, the piece of first SRB information carried in the BS-end connection determination message 350 is configured to indicate which SRB will be used next (for example, to indicate that the SRB0 will be used next) and/or to indicate whether another SRB is going to be established (for example, to indicate that the SRB1 is going to be established). In an embodiment, the BS-end connection determination message 350 comprises an RRC container, and the second RRC message may be carried in the information element of a downlink common control channel comprised in the information element of the RRC container.

Thereafter, the transceiving interface 233b of the distributed unit 233 receives the BS-end connection determination message 350. The processor 233a of the distributed unit 233 learns that the BS-end connection determination message 350 carries an RRC related message (i.e., the second RRC message) after decoding the BS-end connection determination message 350, and then retrieves the second RRC message from the BS-end connection determination message350. In an embodiment, the processor 233a retrieves the second RRC message from the information element of the downlink common control channel comprised in the information element of the RRC container comprised in the BS-end connection determination message 350. Thereafter, the transceiving interface 233c transmits the second RRC message 370 to the user equipment 21 via a downlink common control channel. From the perspective of the mobile communication system 2, the second RRC message 370 transmitted by the distributed unit 233 to the user equipment 21 is the RRC connection determination message responded to the user equipment 21 from the base station 23. After decoding the second RRC message 370, the user equipment 21 learns that the base station 23 accepts or rejects its RRC connection request.

Through the aforesaid process, although the distributed unit 233 cannot decode the RRC connection related message (for example, the RRC connection request message 310 and the second RRC message 370) due to its running communication protocol stack having no RRC layer, the distributed unit 233 can transfer the RRC connection related message to the centralized unit 231 or the user equipment 21. Therefore, the centralized unit 231 and the distributed unit 233 can respond to the RRC connection request of the user equipment 21 through the 2-way handshaking process.

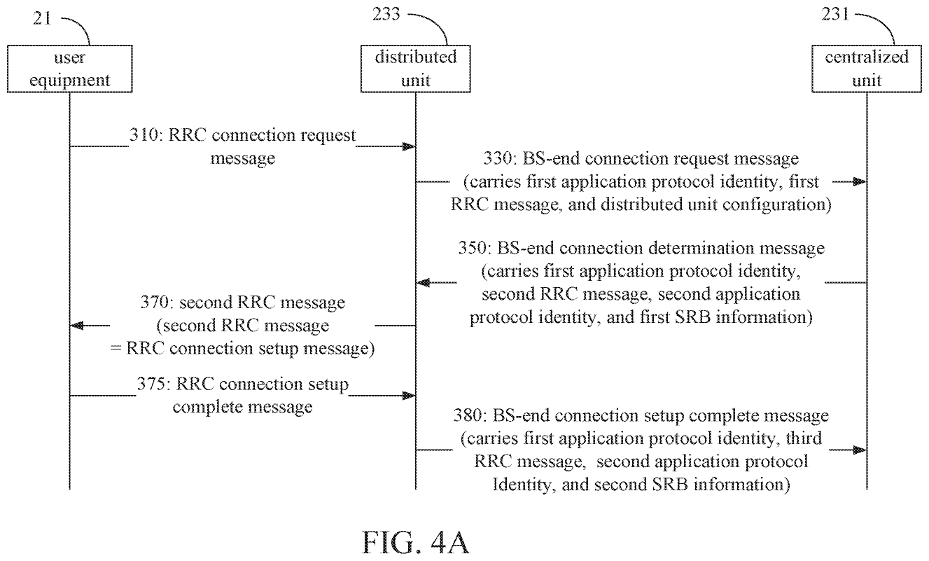

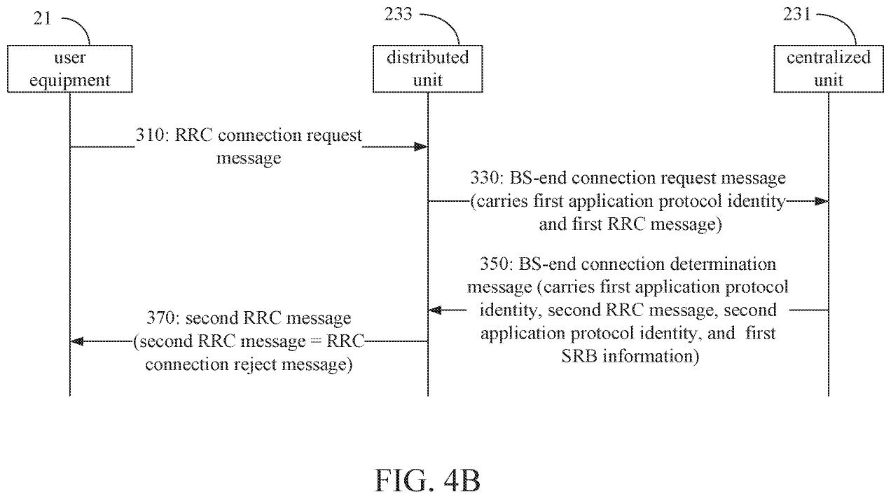

Please refer to FIG. 4A and FIG. 4B, which illustrate schematic views of the message transmission according to the second embodiment of the present invention. In this embodiment, it is the distributed unit 233 of the base station 23 that determines whether to accept the RRC connection request of the user equipment 21, and the distributed unit 233 let the centralized unit 231 know its determination via the BS-end connection request message 330. Specifically, after the transceiving interface 233c of the distributed unit 233 receives the RRC connection request message 310, the processor 233a determines whether to accept the RRC connection request of the user equipment 21 (for example, based on whether the distributed unit 233 has sufficient radio resources at the time). If the processor 233a determines to accept the RRC connection request of the user equipment 21, the processor 233a encapsulate a distributed unit configuration (DU Configuration) into the BS-end connection request message 330. If the processor 233a determines to reject the RRC connection request of the user equipment 21, the processor 233a does not encapsulate a distributed unit configuration into the BS-end connection request message 330. In an embodiment, the distributed unit configuration may be a CellGroupConfig information element defined by the 5G mobile communication system standard, but it is not limited thereto.

In this embodiment, if the base station 23 determines to accept the RRC connection request of the user equipment 21, the base station 23 internally adopts a three-way (3-way) handshaking process (i.e., the BS-end connection request message 330, the BS-end connection determination message 350, and the BS-end connection setup complete message 380 shown in FIG. 4A) to establish an RRC connection for the user equipment 21. If the base station 23 determines to reject the RRC connection request of the user equipment 21, the base station 23 internally adopts the 2-way handshaking process (i.e., the BS-end connection request message 330 and the BS-end connection determination message 350 shown in FIG. 4B) to reject the RRC connection request of the user equipment 21. The following description will focus on the differences between the present embodiment and the first embodiment.

Please refer to FIG. 4A. The case that the processor 233a of the distributed unit 233 determines to accept the RRC connection request of the user equipment 21 is described herein. In this case, the BS-end connection request message 330 generated by the processor 233a of the distributed unit 233 carries not only the first application protocol identity and the first RRC message (as mentioned above, the first RRC message is the RRC connection request message 310) but also a distributed unit configuration. The processor 231a of the centralized unit 231 learns that the user equipment 21 has requested for an RRC connection according to the first application protocol identity and the first RRC message carried in the BS-end connection request message 330 and learns that the distributed unit 233 still has sufficient radio resources to serve a new user equipment according to the distributed unit configuration carried in the BS-end connection request message 330. Therefore, the processor 231a accepts the RRC connection request of the user equipment 21. Hence, the BS-end connection determination message 350 generated by the processor 231a of the centralized unit 231 carries an RRC connection setup message (i.e., the second RRC message carried in the aforesaid BS-end connection determination message 350 is an RRC connection setup message). Similarly, the transceiving interface 231b of the centralized unit 231 transmits the BS-end connection determination message 350 to the distributed unit 233.

Similarly, the distributed unit 233 retrieves the second RRC message after receiving the BS-end connection determination message 350. In an embodiment, the processor 233a retrieves the second RRC message from the information element of the downlink common control channel comprised in the information element of the RRC container comprised in the BS-end connection determination message 350. Thereafter, the transceiving interface 233c transmits the second RRC message 370 to the user equipment 21 via a downlink common control channel. After decoding the second RRC message 370, the user equipment 21 learns that the base station 23 allows it to establish an RRC connection.

After that, the user equipment 21 transmits an RRC connection setup complete message 375 to the distributed unit 233 via an uplink dedicated control channel (UL DCCH), and the RRC connection setup complete message 375 is received by the transceiving interface 233c of the distributed unit 233 via the uplink dedicated control channel. Since the distributed unit 233 receives the RRC connection setup complete message 375 via the uplink dedicated control channel, the distributed unit 233 learns that the received RRC connection setup complete message 375 is an RRC related message without decoding the RRC connection completion message 375.

In response to receiving an RRC related message (i.e., the RRC connection setup complete message 375), the processor 233a generates a BS-end connection setup complete message 380, and the transceiving interface 233b transmits the BS-end connection setup complete message 380 to the centralized unit 231. It should be noted that the BS-end connection setup complete message 380 carries the first application protocol identity, the second application protocol identity, a third RRC message, and a piece of second SRB information. The third RRC message is the RRC connection setup complete message 375 received by the distributed unit 233; in other words, the distributed unit 233 encapsulates the received RRC connection setup complete message 375 into the BS-end connection setup complete message 380. The piece of second SRB information carried in the BS-end connection setup complete message 380 is configured to indicate which SRB will be used next (for example, to indicate that the SRB1 will be used next). In an embodiment, the BS-end connection setup complete message 380 comprises an RRC container, and the third RRC message may be carried in the information element of an uplink dedicated control channel comprised in the information element of the RRC container.

Next, the transceiving interface 231b of the centralized unit 231 receives the BS-end connection setup complete message 380. Then, the processor 231a determines that the BS-end connection setup complete message 380 carries an RRC connection setup complete message by decoding the BS-end connection setup complete message 380 (i.e., determines that the BS-end connection setup complete message 380 carries the third RRC message and determines that the third RRC message is an RRC connection setup complete message after decoding the third RRC message). In an embodiment, the processor 231a retrieves the third RRC message from the information element of the uplink dedicated control channel comprised in the information element of the RRC container comprised in the BS-end connection setup complete message 380 and determines that the third RRC message is an RRC connection setup complete message.

Please refer to FIG. 4B. The case that the processor 233a of the distributed unit 233 determines to reject the RRC connection request proposed by the user equipment 21 is described herein. In this case, the BS-end connection request message 330 generated by the processor 231a does not carry a distributed unit configuration. The processor 231a of the centralized unit 231 learns that the user equipment has requested for an RRC connection according to the first application protocol identity carried by the BS-end connection request message 330 and the first RRC message and learns that the distributed unit 233 does not have sufficient radio resources to serve a new user equipment according to the fact that there is no distributed unit configuration carried in BS-end connection request message 330. Thus, the processor 231a rejects the RRC connection request sent by the user equipment 21. Hence, the BS-end connection determination message 350 generated by the processor 231a carries an RRC connection reject message (i.e., the second RRC message carried by said BS-end connection determination message 350 is an RRC connection reject message). Similarly, the transceiving interface 231b of the centralized unit 231 transmits the BS-end connection determination message 350 to the distributed unit 233.

Similarly, after receiving the BS-end connection determination message 350, the distributed unit 233 retrieves the second RRC message. In an embodiment, the processor 233a retrieves the second RRC message from the information element of the downlink common control channel comprised in the information element of the RRC container comprised in the BS-end connection determination message 350. Thereafter, the transceiving interface 233c transmits the second RRC message 370 to the user equipment 21 via a downlink common control channel After decoding the second RRC message, the user equipment 21 learns that the base station 23 rejects its RRC connection request.

In an embodiment, the base station 23 may use the InitialULRRCMessageTransfer message, the DLRRCMessageTransfer message, and the ULRRCMessageTransfer message in the 5G mobile communication system standard as the BS-end connection request message 330, the BS-end connection determination message 350, and the BS-end connection setup complete message 380 respectively. In such embodiment, the piece of first SRB information carried in the BS-end connection determination message 350 is the SRB identity (ID) in the DLRRCMessageTransfer message, and the SRB identity is set to be “0” for indicating that the SRB to be used next is SRB0. In addition, the piece of second SRB information carried in the BS-end connection setup complete message 380 is the SRB identity in the ULRRCMessageTransfer message, and the SRB identity is set to be “1” for indicating that the SRB to be used next is SRB1 (i.e., another SRB different from SRB0).

In another embodiment, the base station 23 may use the InitialULRRCMessageTransfer message in the 5G mobile communication system standard as the BS-end connection request message 330. In addition, the base station may define a UEConnectionSetup message as the BS-end connection determination message 350 and define a UEConnectionSetupComplete message as the BS-end connection setup complete message 380.

According to the above description, the centralized unit 231 of the present embodiment will be informed of whether to accept or reject the RRC connection request of the user equipment 21 according to whether the BS-end connection request message 330 carries a distributed unit configuration. To accept the RRC connection request of the user equipment 21, the base station 23 internally adopts the 3-way handshaking process. To reject the RRC connection request of the user equipment 21, the base station 23 internally adopts the 2-way handshaking process. Thereby, the base station 23 can respond to the RRC connection request sent by the user equipment 21 without adding too much internal contact messages of the base station 23.

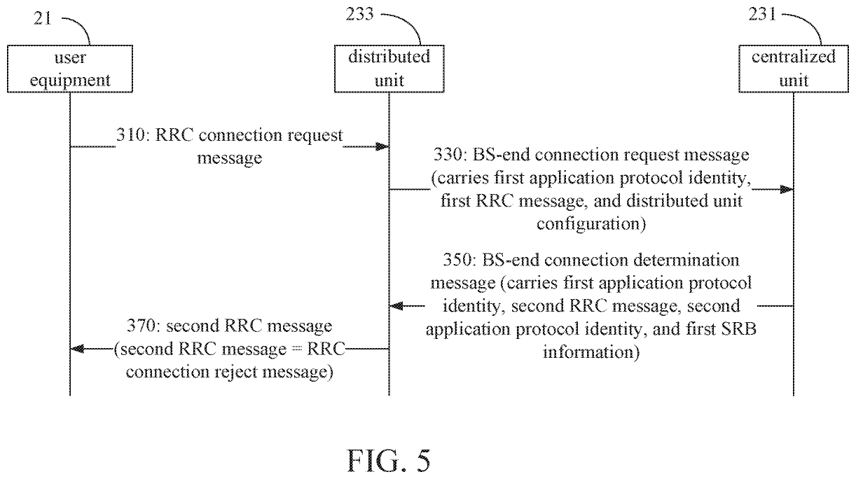

Please refer to FIG. 4A and FIG. 5, which illustrate the schematic views of the message transmission according to the third embodiment of the present invention. The third embodiment is similar to the second embodiment, but the BS-end connection request message 330 in the third embodiment has to carry a distributed unit configuration so that the centralized unit 231c an determine whether to accept the RRC connection request of the user equipment 21 with reference to the distributed unit configuration and/or a centralized unit configuration (CU configuration). The following description will focus on the differences between the third embodiment and the second embodiment.

As described above, after the transceiving interface 233c of the distributed unit 233 receives the RRC connection request message 310, the processor 233a of the distributed unit 233 generates the BS-end connection request message 330. In this embodiment, the BS-end connection request message 330 is required to carry a distributed unit configuration in addition to the first application protocol identity and the first RRC message. After the transceiving interface 231b of the centralized unit 231 receives the BS-end connection request message 330, the processor 231a determines whether to accept the RRC connection request of the user equipment 21 according to the distributed unit configuration and/or the centralized unit configuration of the centralized unit 231 its own. In an embodiment, the centralized unit configuration may be a piece of load-related information (e.g., whether the transmission has to be barred due to the core network 25 being overloaded) received by the transceiving interface 231c of the centralized unit 231 from the core network 25, but it is not limited thereto.

Please refer to FIG. 5 for the case that the processor 231a of the centralized unit 231 determines to reject the RRC connection request of the user equipment 21. In this case, the BS-end connection determination message 350 generated by the processor 231a carries an RRC connection reject message (i.e., the aforesaid second RRC message carried in the BS-end connection determination message 350 is an RRC connection reject message). Similarly, the transceiving interface 231b transmits the BS-end connection determination message 350 to the distributed unit 233. Similarly, after the distributed unit 233 receives the BS-end connection determination message 350, the distributed unit 233 retrieves the second RRC message. In an embodiment, the processor 233a retrieves the second RRC message from the information element of the downlink common control channel comprised in the information element of the RRC container comprised in the BS-end connection determination message 350. Thereafter, the transceiving interface 233c transmits the second RRC message 370 to the user equipment 21 via the downlink common control channel After decoding the second RRC message, the user equipment 21 learns that the base station 23 rejects its RRC connection request.

Now, please refer to FIG. 4A for the case that the processor 231a of the centralized unit 231 determines to accept the RRC connection request of the user equipment 21. In this case, the BS-end connection determination message 350 generated by the processor 231a carries an RRC connection setup message (i.e., the aforesaid second RRC message carried in the BS-end connection determination message 350 is an RRC connection setup message). Similarly, the transceiving interface 231b transmits the BS-end connection determination message 350 to the distributed unit 233. Similarly, after receiving the BS-end connection determination message 350, the distributed unit 233 retrieves the second RRC message. In an embodiment, the processor 233a retrieves the second RRC message from the information element of the downlink common control channel comprised in the information element of the RRC container comprised in the BS-end connection determination message 350. Thereafter, the transceiving interface 233c transmits the second RRC message 370 to the user equipment 21 via the downlink common control channel After the user equipment 21 decodes the second RRC message, it learns that the base station 23 accepts its RRC connection request.

In an embodiment, the base station 23 may use the InitialULRRCMessageTransfer message, the DLRRCMessageTransfer message, and the ULRRCMessageTransfer message in the 5G mobile communication system standard as the BS-end connection request message 330, the BS-end connection determination message 350, and the BS-end connection setup complete message 380 respectively

In such embodiment, the piece of first SRB information carried in the BS-end connection determination message 350 comprises the SRB identity in the DLRRCMessageTransfer message and/or the “SRB to be Setup” field in the DLRRCMessageTransfer message. The SRB identity comprised in the piece of first SRB information is set to be “0” for indicating that the SRB to be used next is the SRB0. In addition, if the centralized unit 231 rejects the RRC connection request of the user equipment 21, the “SRB to be Setup” field comprised in the piece of first SRB information is set to be “0” (i.e., no other SRB is going to be established, which means rejecting the RRC connection request of the user equipment 21). If the centralized unit 231 accepts the RRC connection request of the user equipment 21, the “SRB to be Setup” field comprised in the piece of first SRB information is set to be “1” (i.e., the SRB1 is going to be established, which means accepting the RRC connection request of the user equipment 21). Furthermore, the second SRB information carried in the BS-end connection setup complete message 380 is the SRB identity in the ULRRCMessageTransfer message, and the SRB identity is set to be “1” for indicating that the SRB to be used next is the SRB1 (i.e., another SRB different from the SRB0).

In another embodiment, the base station 23 may use the InitialULRRCMessageTransfer message in the 5G mobile communication system standard as the BS-end connection request message 330. In addition, in the case that the base station 23 rejects the RRC connection request of the user equipment 21, the base station 23 may define a UEConnectionReject message as the BS-end connection determination message 350. In the case that the base station 23 accepts the RRC connection request of the user equipment 21, the base station 23 may further define a UEConnectionSetup message as the BS-end connection determination message 350. In addition, the base station 23 may further define a UEConnectionSetupComplete message as the BS-end connection setup complete message 380.

From the above description, it is learned that the centralized unit 231 of the present embodiment may determine whether to accept or reject the RRC connection request of the user equipment 21 according to the distributed unit configuration transmitted from the distributed unit 233 and/or the centralized unit configuration of the centralized unit 231 its own. To accept the RRC connection request of the user equipment 21, the base station 23 internally adopts the 3-way handshaking process. To reject the RRC connection request of the user equipment 21, the base station 23 internally adopts the 2-way handshaking process. Thereby, the base station 23 can respond to the RRC connection request sent by the user equipment 21 without adding too much internal contact messages of the base station 23.

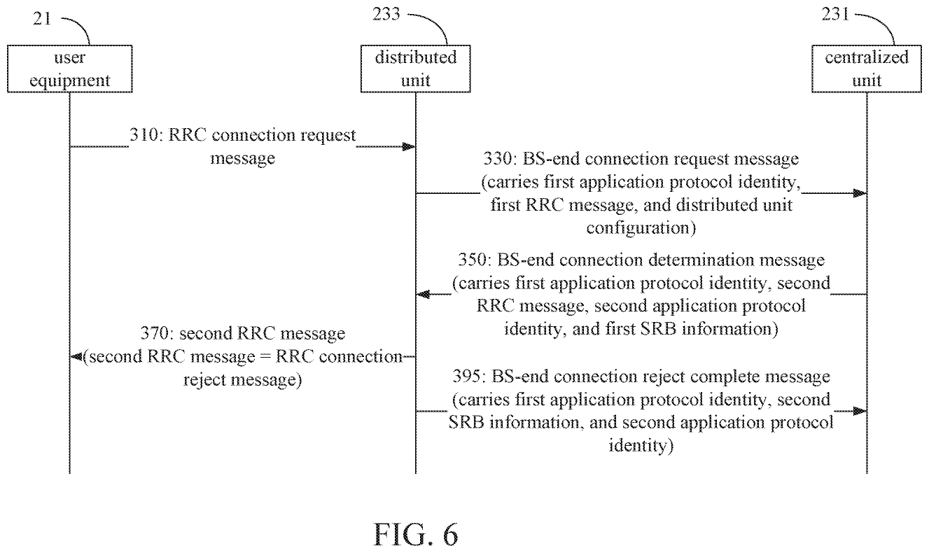

Please refer to FIG. 6, which illustrates a schematic view of the message transmission according to the fourth embodiment of the present invention. The fourth embodiment is an extension of the third embodiment. The fourth embodiment and the third embodiment operate slightly differently for rejecting the RRC connection request of the user equipment 21. The following description will focus on the differences between these two embodiments.

It is assumed that the processor 231a of the centralized unit 231 determines to reject the RRC connection request of the user equipment 21. In this embodiment, after the distributed unit 233 receives the BS-end connection determination message 350 (the second RRC message carried therein is an RRC connection reject message), the processor 233a further generates a BS-end connection reject complete message 395 and the transceiving interface 233b transmits the BS-end connection reject complete message 395 to the centralized unit 231. It should be noted that the BS-end connection reject complete message 395 carries a first application protocol identity, a second application protocol identity, and a piece of second SRB information. The piece of second SRB information carried in the BS-end connection reject complete message 395 is configured to indicate that a certain SRB has not been successfully established (e.g., SRB1 is not successfully established).

The transceiving interface 231b of the centralized unit 231 receives the BS-end connection reject complete message 395, and thus learns that the distributed unit 233 has received the BS-end connection determination message 350. It should be understood that the order to transmit the BS-end connection reject complete message 395 and the second RRC message by the distributed unit 233 is not limited by the present invention. The distributed unit 233 may first transmit the BS-end connection reject complete message 395 and then transmit the second RRC message 370, may first transmit the second RRC message 370 and then transmit the BS-end connection reject complete message 395, or may simultaneously transmit the BS-end connection reject complete message 395 and the second RRC message 370.

In an embodiment, the base station 23 may use the InitialULRRCMessageTransfer message and the DLRRCMessageTransfer message in the 5G mobile communication system standard as the BS-end connection request message 330 and the BS-end connection determination message 350 respectively, and define a DLRRCMessageTransferResponse message as the BS-end connection reject complete message 395. In such embodiment, the piece of first SRB information carried in the BS-end connection determination message 350 is the SRB identity (ID) in the DLRRCMessageTransfer message, and the SRB identity is set to be “0” for indicating that the SRB to be used next is the SRB0. The piece of second SRB information carried in the BS-end connection reject complete message 395 is the “SRB Failed to be Setup List” field defined in the DLRRCMessageTransferResponse message, and the distributed unit 233 may indicate that the SRB1 is not successfully established by recording the value of SRB1 to be “1” in the “SRB Failed to be Setup List” field (i.e., the distributed unit 233 thereby notifies the centralized unit 231 that it has completed the release of the distributed unit configuration.

In another embodiment, the base station 23 may use the InitialULRRCMessageTransfer message in the 5G mobile communication system standard as the BS-end connection request message 330, may define a UEConnectionReject message as the BS-end connection determination message 350, and may define a UEConnectionRejectComplete message as the BS-end connection reject complete message 395.

Compared with the third embodiment, when the base station 233 rejects the RRC connection request of the user equipment 21, the distributed unit 233 of the present embodiment further transmits the BS-end connection reject complete message 395 to the centralized unit 231 to notify the centralized unit 231 that the distributed unit 233 has indeed decoded the BS-end connection determination message 350 transmitted previously. Through the aforesaid process, the base station 23 can reject the RRC connection request of the user equipment 21 by a simply internal 3-way handshaking process.

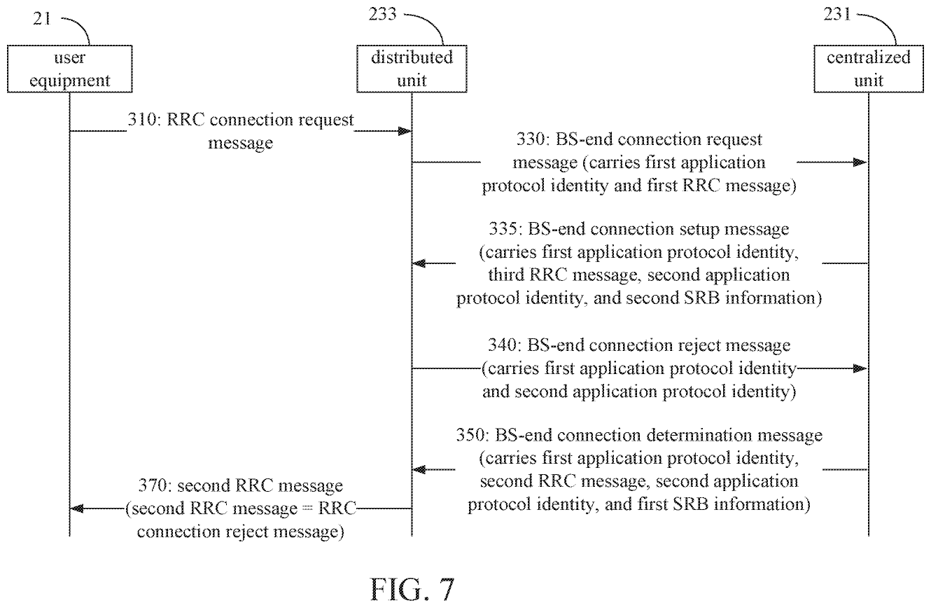

Please refer to FIG. 7, which illustrates a schematic view of the message transmission according to the fifth embodiment of the present invention. In this embodiment, the centralized unit 231 first determines to accept the RRC connection request of the user equipment 21, but the distributed unit 233 subsequently determines that the RRC connection request of the user equipment 21 cannot be accepted (for example, the distributed unit 233 determines that the radio resources is not enough at that time). Therefore, the base station 23 does not establish an RRC connection for the user equipment 21. The following description will focus on the differences between the present embodiment and the first embodiment.

In this embodiment, after the centralized unit 231 receives the BS-end connection request message 330, the processor 231a determines to accept the RRC connection request of the user equipment 21. Therefore, the processor 231a generates a BS-end connection setup message 335, and then the transceiving interface 231b transmits the BS-end connection setup message 335 to the distributed unit 233. It should be noted that the BS-end connection setup message 335 carries the first application protocol identity, the second application protocol identity, a third RRC message, and a piece of second SRB information, wherein the third RRC message is an RRC connection setup message. The piece of second SRB information carried in the BS-end connection setup message 335 is configured to indicate which SRB will be used next (for example, to indicate that the SRB0 will be used next) and/or to indicate that another SRB will be established (for example, to establish the SRB1). In an embodiment, the BS-end connection setup message 335 comprises an RRC container, and the third RRC message may be carried in the information element of the downlink common control channel comprised in the information element of the RRC container.

Next, the transceiving interface 233b of the distributed unit 233 receives the BS-end connection setup message 335. The distributed unit 233 learns that the BS-end connection setup message 335 carries an RRC related message (i.e., the third RRC message) after decoding the BS-end connection setup message 335. In an embodiment, the processor 233a is learned that the BS-end connection setup message 335 carries the RRC related message due to the information element of the downlink common control channel is comprised in the information element of the RRC container comprised in the BS-end connection setup message 335.

In this embodiment, after the distributed unit 233 receives the BS-end connection setup message 335, the processor 233a determines that the RRC connection cannot be established (for example, determines that the distributed unit 233 does not have enough radio resources at that time to establish an RRC connection). Based on the result of the determination, the processor 233a generates a BS-end connection reject message 340, and the transceiving interface 233b further transmits the BS-end connection reject message 340 to the centralized unit 231. It should be noted that the BS-end connection reject message 340 carries a first application protocol identity and a second application protocol identity. In an embodiment, the BS-end connection reject message 340 may further carry the cause that the distributed unit 233 cannot establish a connection.

The transceiving interface 231b of the centralized unit 231 receives the BS-end connection reject message 340. By receiving the BS-end connection reject message 340, the centralized unit 231 learns that the distributed unit 233 cannot establish an RRC connection for the user equipment 21. Therefore, the BS-end connection determination message 350 generated by the processor 231a of the centralized unit 231 carries an RRC connection reject message (i.e., the aforesaid second RRC message carried in the BS-end connection determination message 350 is an RRC connection reject message). Similarly, the transceiving interface 233b of the distributed unit 233 transmits the second RRC message 370 to the user equipment 21 after receiving the BS-end connection determination message 350. After decoding the second RRC message, the user equipment 21 learns that the base station 23 rejects its RRC connection request.

In an embodiment, the base station 23 may use the InitialULRRCMessageTransfer message and the DLRRCMessageTransfer in the 5G mobile communication system standard as the BS-end connection request message 330 and the BS-end connection setup message 335 respectively. The base station 23 may define an RRCMessageTransferResponse message as the BS-end connection reject message 340. In addition, the base station 23 may further use the DLRRCMessageTransfer message in the 5G mobile communication system standard as the BS-end connection determination message 350.

In such embodiment, the piece of second SRB information carried in the BS-end connection setup message 335 is the “SRB to be Setup” field in the DLRRCMessageTransfer message and/or the SRB identity. The processor 231a of the centralized unit 231 may accept the RRC connection request of the user equipment 21 by setting the value of the “SRB to be Setup” field to be “1” (i.e., to establish the SRB1) and/or by setting the SRB identity to be “0” (which represents that the SRB to be used next is the SRB0). The piece of first SRB information carried in the BS-end connection determination message 350 is the SRB identity in the DLRRCMessageTransfer message. The centralized unit 231 may indicate that the SRB to be used next is the SRB0 by setting the value of the piece of first SRB information to be “0.”

In another embodiment, the base station 23 may use the InitialULRRCMessageTransfer message in the 5G mobile communication system standard as the BS-end connection request message 330. In addition, the base station 23 may define a UEConnectionSetupRequest message as the BS-end connection setup message 335, define a UEConnectionReject message as the BS-end connection reject message 340, and define a UEConnectionRejectResponse message as the BS-end connection determination message 350.

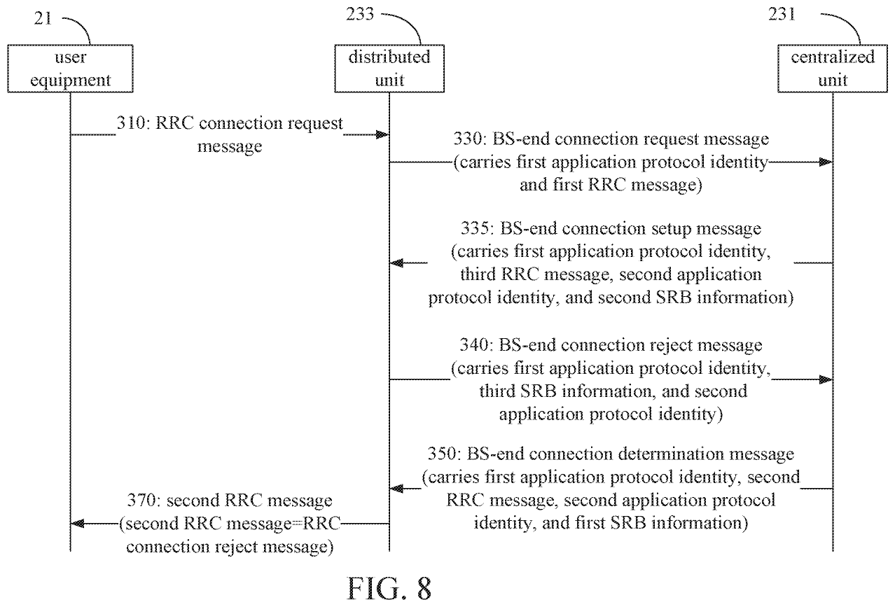

Please refer to FIG. 8, which illustrates a schematic view of the message transmission according to the sixth embodiment of the present invention. The sixth embodiment is similar to the fifth embodiment, and the main difference between the two embodiments is that the BS-end connection reject message 340 of the present embodiment further comprises a piece of third SRB information. The piece of third SRB information carried in the BS-end connection reject message 340 is configured to indicate that a certain SRB cannot be successfully established (for example, the SRB1 cannot be successfully established).

In an embodiment, the base station 23 may use the InitialULRRCMessageTransfer message and the DLRRCMessageTransfer message in the 5G mobile communication system standard as the BS-end connection request message 330 and the BS-end connection setup message 335 respectively. In addition, the base station 23 may define an RRCMessageTransferResponse message as the BS-end connection reject message 340 and may use the DLRRCMessageTransfer message in the 5G mobile communication system standard as the BS-end connection determination message 350.

In such embodiment, the piece of second SRB information carried in the BS-end connection setup message 335 is the “SRB to be Setup” field in the DLRRCMessageTransfer message and/or the SRB identity. The processor 231a of the centralized unit 231 may accept the RRC connection request of the user equipment 21 by setting the value of the “SRB to be Setup” field to be “1” and/or by setting the SRB identity to be “0” (which represents that the SRB can be used next is the SRB0). The piece of third SRB information carried in the BS-end connection reject message 340 is the “SRB Failed to be Setup List” field defined in the RRCMessageTransferResponse message. The processor 233a of the distributed unit 233 may indicate that the SRB1 is not established by recording the value of the SRB1 to be “1” in the “SRB Failed to be Setup List” field (i.e., rejecting the RRC connection request of the user equipment 21). The piece of first SRB information carried in the BS-end connection determination message 350 is the SRB identity in the DLRRCMessageTransfer message. The centralized unit 231 may indicate that the SRB that can be used next is the SRB0 by setting the value of the piece of first SRB information to be “0.”

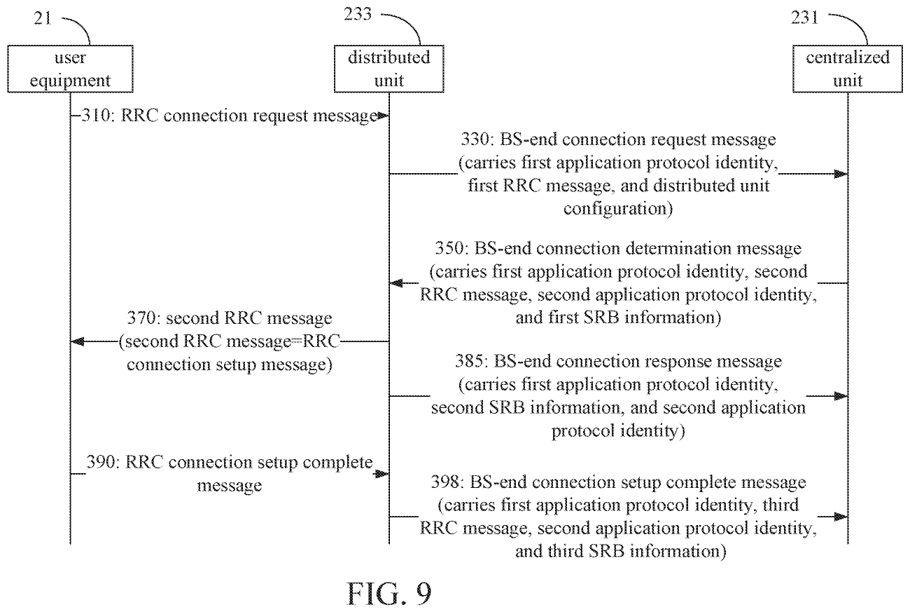

Please refer to FIG. 9, which illustrates a schematic view of the message transmission according to the seventh embodiment of the present invention. In this embodiment, the BS-end connection request message 330 must carry a distributed unit configuration. The centralized unit 231 determines whether to accept the RRC connection request of the user equipment 21 according to the distributed unit configuration and/or the state of the core network 25. In addition, in response to the RRC connection request of the user equipment 21, the base station 23 internally adopts a four-way (4-way) handshaking process (i.e., the BS-end connection request message 330, the BS-end connection determination message 350, the BS-end connection response message 385, and the BS-end connection setup complete message 398 shown in FIG. 9). The following description will focus on the differences between the present embodiment and the first embodiment.

As described above, after the transceiving interface 233c of the distributed unit 233 receives the RRC connection request message 310, the processor 233a of the distributed unit 233 generates a BS-end connection request message 330. In this embodiment, the BS-end connection request message 330 carries a distributed unit configuration in addition to the first application protocol identity and the first RRC message. After the centralized unit 231 receives the BS-end connection request message 330, it determines to accept the RRC connection request of the user equipment 21 according to the distributed unit configuration and/or the state of the core network 25, and therefore the BS-end connection determination message 350 generated by the processor 231a carries an RRC connection setup message (i.e., the aforesaid second RRC message carried in the BS-end connection determination message 350 is an RRC connection setup message).

Similarly, after receiving the BS-end connection request message 330, the centralized unit 231 transmits the BS-end connection determination message 350 to the distributed unit 233. In this embodiment, after the distributed unit 233 receives the BS-end connection determination message 350, the distributed unit 233 further generates a BS-end connection response message 385, and then the transceiving interface 233b transmits the BS-end connection response message 385 to the centralized unit 231. It should be noted that the BS-end connection response message 385 carries a first application protocol identity, a second application protocol identity, and a piece of second SRB information. The piece of second SRB information carried in the BS-end connection response message 385 is configured to indicate whether a certain SRB is successfully established. It should be noted that the present invention does not limit the order for transmitting the second RRC message 370 and the BS-end connection response message 385 by the distributed unit 233. The distributed unit 233 may first transmit the second RRC message 370 and then transmit the BS-end connection response message 385, may first transmit the BS-end connection response message 385 and then transmits the second RRC message 370, or may simultaneously transmits the second RRC message 370 and the BS-end connection response message 385.

The transceiving interface 231b of the centralized unit 231 receives the BS-end connection response message 385. Because of receiving the BS-end connection response message 385, the centralized unit 231 learns that the distributed unit 233 does receive the BS-end connection request message 330 transmitted from the centralized unit 231.

In this embodiment, after decoding the second RRC message 370, the user equipment 21 learns that the base station 23 accepts its RRC connection request. Then, the user equipment 21 transmits an RRC connection setup complete message 390 to the distributed unit 233 via an uplink dedicated control channel, and the RRC connection setup complete message 390 is received by the transceiving interface 233c of the distributed unit 233 via the uplink dedicated control channel Since the distributed unit 233 receives the RRC connection setup complete message 390 via the uplink dedicated control channel, the distributed unit 233 learns that the received RRC connection setup complete message 390 is an RRC related message without decoding the RRC connection setup complete message 390.

In response to receiving an RRC related message (i.e., the RRC connection setup complete message 390), the processor 233a generates a BS-end connection setup complete message 398, and the transceiving interface 233b transmits the BS-end connection setup complete message 398 to the centralized unit 231. It should be noted that the BS-end connection setup complete message 398 carries the first application protocol identity, the second application protocol identity, a third RRC message, and a piece of third SRB information. The third RRC message is the RRC connection setup complete message received by the distributed unit 233; in other words, the distributed unit 233 encapsulates the received RRC connection setup complete message 390 into the BS-end connection request message 398. The piece of third SRB information carried in the BS-end connection setup complete message 398 is configured to indicate which SRB will be used next (e.g., the SRB1 will be used next). In an embodiment, the BS-end connection setup complete message 398 comprises an RRC container, and the third RRC message may be carried in the information element of an uplink dedicated control channel comprised in the information element of the RRC container.

Next, the transceiving interface 231b of the centralized unit 231 receives the BS-end connection setup complete message 398. The processor 231a then determines that the BS-end connection setup complete message 398 carries an RRC connection setup complete message by decoding the BS-end connection setup complete message 398 (i.e., determines that the BS-end connection setup complete message 398 carries the third RRC message and determines that the third RRC message is an RRC connection setup complete message after decoding the third RRC message). In an embodiment, the processor 231a retrieves the third RRC message from the information element of the uplink dedicated control channel comprised in the information element of the RRC container comprised in the BS-end connection setup complete message 398 and determines that the third RRC message is an RRC connection setup complete message.

In an embodiment, the base station 23 may use the InitialULRRCMessageTransfer message and the DLRRCMessageTransfer message in the 5G mobile communication system standard as the BS-end connection request message 330 and the BS-end connection determination message 350 respectively. In addition, the base station 23 may define an RRCMessageTransferResponse message as the BS-end connection response message 385 and may use the ULRRCMessageTransfer message in the 5G mobile communication system standard as the BS-end connection setup complete message 398.

In this embodiment, the piece of first SRB information carried in the BS-end connection determination message 350 is the “SRB to be Setup” field in the DLRRCMessageTransfer message and/or the SRB identity. The centralized unit 231 may accept the RRC connection request of the user equipment 21 by setting the value of the “SRB to be Setup” field to be “1.” In addition, the centralized unit 231 may set the SRB identity to be “0” (which represents that the SRB to be used next is the SRB0). The piece of second SRB information carried in the BS-end connection response message 385 is the “SRB Failed to be Setup List” field defined in the RRCMessageTransferResponse message. The distributed unit 233 may confirm that the SRB1 can be established by recording the value of the SRB1 to be “0” in the “SRB Failed to be Setup List” field (i.e., determine to accept the RRC connection request of the user equipment 21). The piece of third SRB information carried in the BS-end connection setup complete message 398 is the SRB identity in the ULRRCMessageTransfer message, and the SRB identity is set to be “1” for indicating that the SRB to be used next is the SRB1.

In another embodiment, the base station 23 may use the InitialULRRCMessageTransfer message in the 5G mobile communication system standard as the BS-end connection request message 330, define a UEConnectionSetupRequest message as the BS-end connection determination message 350, define a UEConnectionSetupResponse message as the BS-end connection response message 385, and define a UEConnectionSetupComplete message as the BS-end connection setup complete message 398.

Compared with the aforesaid embodiments, the distributed unit 233 of the present embodiment further transmits the BS-end connection response message 385 so that the centralized unit 231 learns that the distributed unit 233 has indeed decoded the BS-end connection determination message 350 which is previously transmitted. In addition, after the RRC connection is established, the distributed unit 233 further transmits the BS-end connection setup complete message 398 to the centralized unit 231. Through the aforesaid process, the base station 23 can communicate internally in the 4-way handshaking process to establish the RRC connection for the user equipment 21.

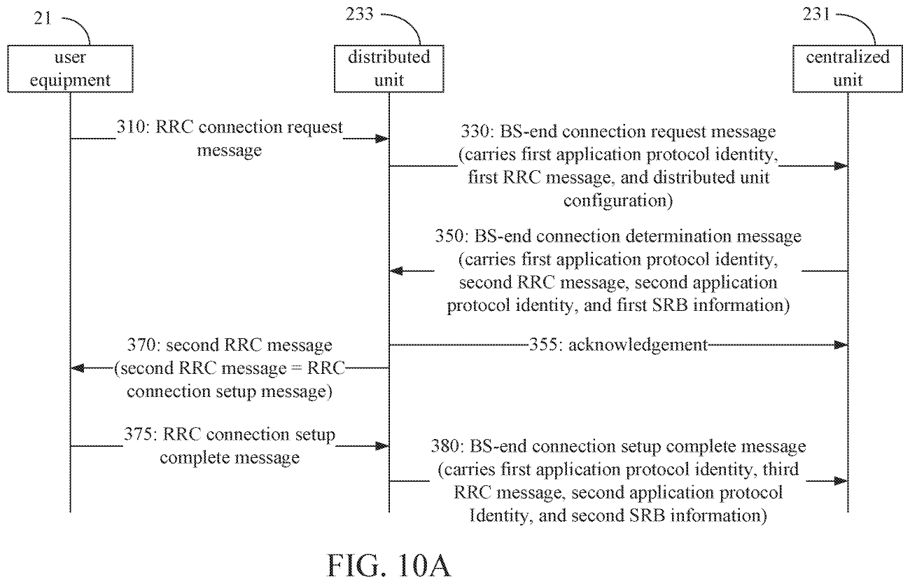

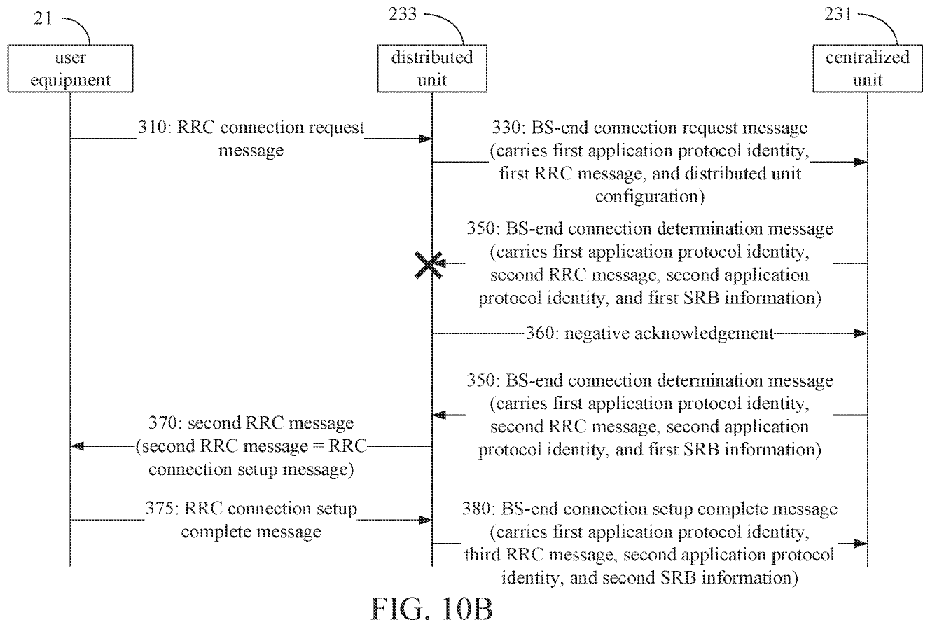

Please refer to FIG. 10A and FIG. 10B, which illustrate schematic views of the message transmission according to the eighth embodiment of the present invention. This embodiment is similar to the second embodiment, and the main difference between the two embodiments is that the present embodiment provides a mechanism for responding to the BS-end connection determination message 350 transmitted by the centralized unit 231. The following description will focus on the differences between these two embodiments.

In this embodiment, after the distributed unit 233 transmits the BS-end connection request message 330 to the centralized unit 231, the distributed unit 233 expects to receive the BS-end connection determination message 350. FIG. 10A illustrates the case when the distributed unit 233 receives the BS-end connection determination message 350. In this case, the transceiving interface 233b of the distributed unit 233 transmits an acknowledgement 355 to the centralized unit 231. After the transceiving interface 231b of the centralized unit 231 receives the acknowledgement 355, the centralized unit 231 learns that the BS-end connection determination message 350 is indeed received by the distributed unit 233. FIG. 10B illustrates the case when the distributed unit 233 does not received the BS-end connection determination message 350. In this case, the transceiving interface 233b transmits a negative acknowledgement 360 to the centralized unit 231. After the transceiving interface 231b of the centralized unit 231 receives the negative acknowledgement 360, the transceiving interface 231b retransmits the BS-end connection determination message 350 to the distributed unit 233.

Compared with the second embodiment, the distributed unit 233 of the present embodiment transmits the acknowledgement 355 or the negative acknowledgement 360, and thus the centralized unit 231 will learn whether the BS-end connection determination message 350 previously transmitted has been received by the distributed unit 233. If the centralized unit 231 receives the negative acknowledgement 360, it will retransmit the BS-end connection determination message 350. The reliability of the base station 23 can be improved by the operation mechanism of the present embodiment.

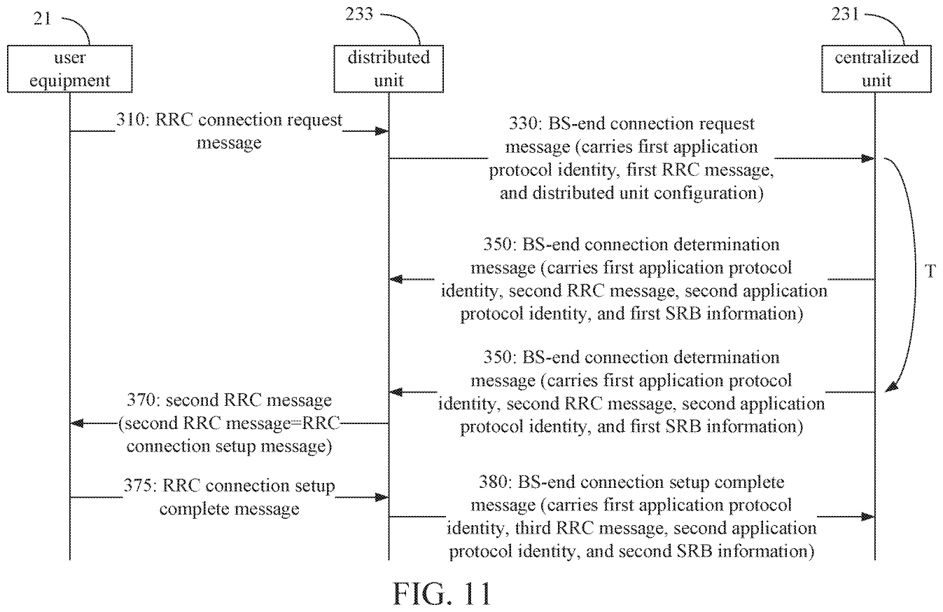

Please refer to FIG. 11, which illustrates a schematic view of the message transmission according to the ninth embodiment of the present invention. This embodiment is similar to the second embodiment, and the main difference between the two embodiments is that the centralized unit 231 further has a mechanism for retransmitting the BS-end connection determination message 350, thereby improving the reliability of the base station 23. The following description will focus on the differences between these two embodiments.

In the embodiment, the processor 231a starts a timer (not shown) upon the transceiving interface 231b of the centralized unit 231 receives the BS-end connection request message 330. The transceiving interface 231b of the centralized unit 231 retransmits the BS-end connection determination message 350 to the distributed unit 233 after the timer has started for a preset length of time T, which increases the probability that the distributed unit 233 receives the BS-end connection determination message 350 and thereby increases the reliability of the base station 23.

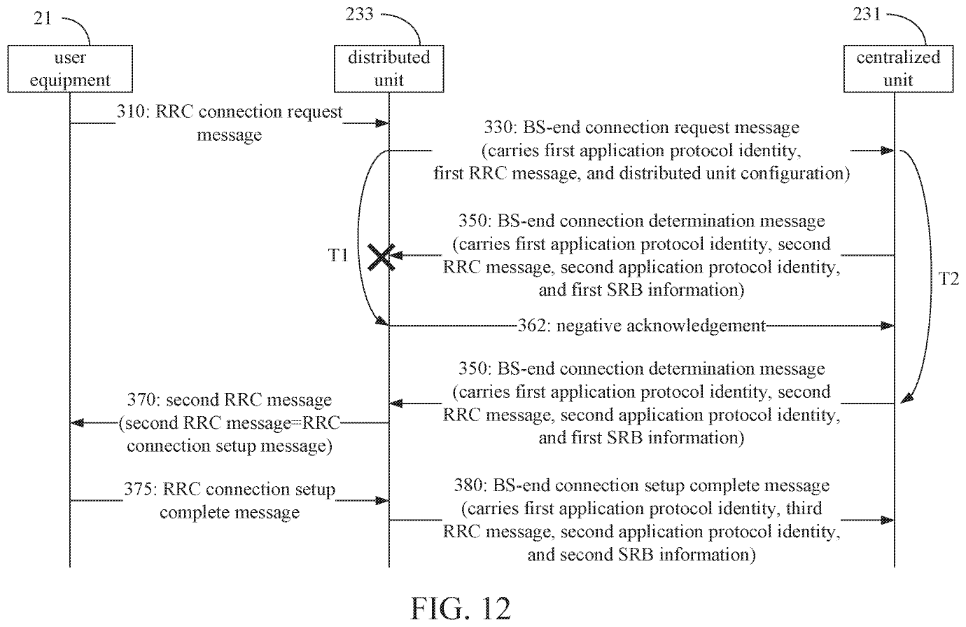

Please refer to FIG. 12, which illustrates a schematic view of the message transmission according to the tenth embodiment of the present invention. The present embodiment is similar to the second embodiment, and the main difference between the two embodiments is that the present embodiment provides a mechanism for responding to the BS-end connection determination message 350 transmitted by the centralized unit 231 so that the centralized unit 231 can learn that whether the BS-end connection determination message 350 is required to be retransmitted. The following description will focus on the differences between these two embodiments.

In this embodiment, the distributed unit 233 starts a first timer (not shown) right after transmitting the BS-end connection request message 330 to the centralized unit 231 and expects to receive the BS-end connection determination message 350 within a preset length of time T1 after the first timer is started. In addition, the processor 231a of the centralized unit 231 starts a second timer upon the transceiving interface 231b receiving the BS-end connection request message 330 (not shown).

If the distributed unit 233 receives the BS-end connection determination message 350 within the preset length of time T1 after the first timer is started, the transceiving interface 233b of the distributed unit 233 will transmit an acknowledgement (not shown) to the centralized unit 231. If the distributed unit 233 does not receive the BS-end connection determination message 350 within the preset length of time T1 after the first timer is started, the transceiving interface 233b of the distributed unit 233 will transmit an negative acknowledgement 362 to the centralized unit 231 If the transceiving interface 231b of the centralized unit 231 receives the negative acknowledgement 362 within the preset time length T2 after the timer is started, the transceiving interface 231b will retransmit the BS-end connection determination message 350 to the distributed unit 233 after receiving the negative acknowledgement 362. With this mechanism, the reliability of the base station 23 can be improved.

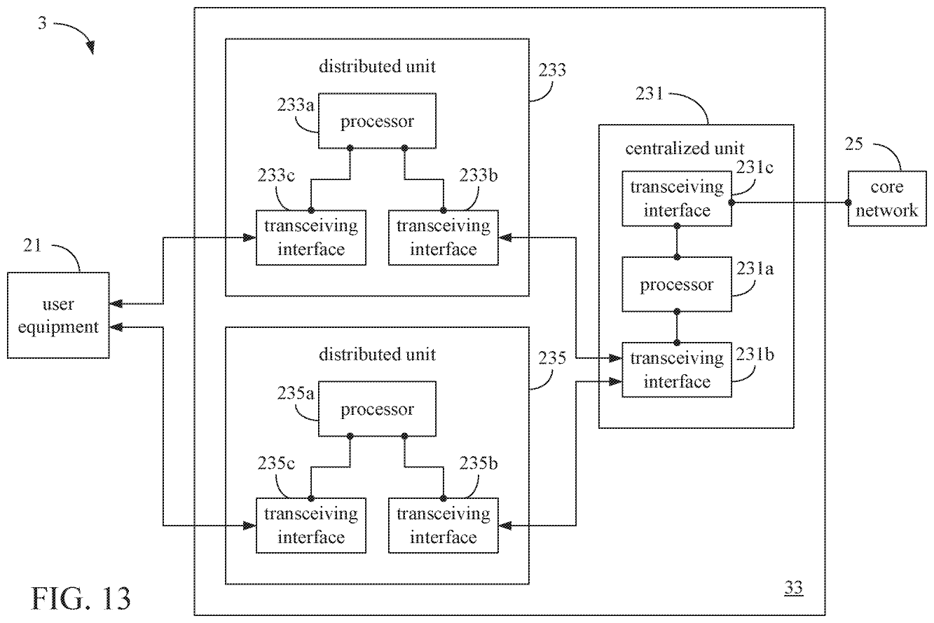

FIG. 13 illustrates a schematic view of the architecture of a mobile communication system 3 according to some embodiments of the present invention. The mobile communication system 3 conforms to the specifications of the 5G mobile communication system and comprises a user equipment 21, a base station 33, and a core network 25. The base station 33 adopts a RAN functional split. In contrast to the base station 23, the base station 33 further comprises another distributed unit 235 in addition to the centralized unit 231 and the distributed unit 233. It should be noted that the structures and operations of the user equipment 21, the centralized unit 231, and the distributed unit 233 in the mobile communication system 3 have been described in detail in the aforesaid embodiments, and thus will not be repeated. Only the differences between the mobile communication system 3 and the mobile communication system 2 will be described below.

The distributed unit 235 performs the lower several layers of the communication protocol stack. If the base station 33 follows the second option of the RAN functional split of the 5G mobile communication system (but not limited thereto), the distributed unit 235 performs the RLC layer, the MAC layer, and the PHY layer of the communication protocol stack. The distributed unit 235 comprises a processor 235a and two transceiving interfaces 235b and 235c, and the processor 235a is electrically connected to the transceiving interfaces 235b and 235c. The processor 235a may be one of a variety of processing units, central processing units, microprocessors, digital signal processors, or any other computing device with same function known by a person having ordinary skills in the art. The transceiving interface 235b may be any wired or wireless interface capable of communicating with a centralized unit, and the transceiving interface 235c may be any wired or wireless interface capable of communicating with a user equipment.

In some embodiments, the centralized unit 231, the distributed unit 233, and the distributed unit 235 may each be an individual hardware device. In some other embodiments, the centralized unit 231, the distributed unit 233, and the distributed unit 235 may be integrated into the same hardware device.

As described above, a logical interface (in the 5G mobile communication system, it is called an Fl interface) is established between the distributed unit 233 and the centralized unit 231, and the messages between the distributed unit 233 and the centralized unit 231 are transmitted via the logical interface and by the physical transceiving interface 233b and transceiving interface 231b. Similarly, another logical interface (in the 5G mobile communication system, it is called an Fl interface) is established between the distributed unit 235 and the centralized unit 231, and the messages between the distributed unit 235 and the centralized unit 231 are transmitted via another logical interface and by the physical transceiving interface 235b and the transceiving interface 231b.

A message related to the user equipment 21 has to carry the aforesaid second application protocol identity in order to be transmitted by the centralized unit 231 to the distributed unit 235, wherein the second application protocol identity is as described above and will not be described again. In addition, a message related to the user equipment 21 has to carry a third application protocol identity (not shown) in order to be transmitted by the distributed unit 235 to the centralized unit 231, and the third application protocol identity is configured to uniquely identify the user equipment 21 over the logical interface (over the physical transceiving interface 235b and transceiving interface 231b) within the distributed unit 235. For example, the distributed unit 235 may concatenate its own identity and a temporary cell radio network temporary identifier (tc-RNTI) as the third application protocol identity. It should be noted that the present invention does not limit the actual content of the third application protocol identity as long as the aforesaid identification effect may be achieved. In some embodiments, the distributed unit 233 may adopt the gNB-DU UE F1AP ID parameter in the 5G mobile communication system as the third application protocol identity.

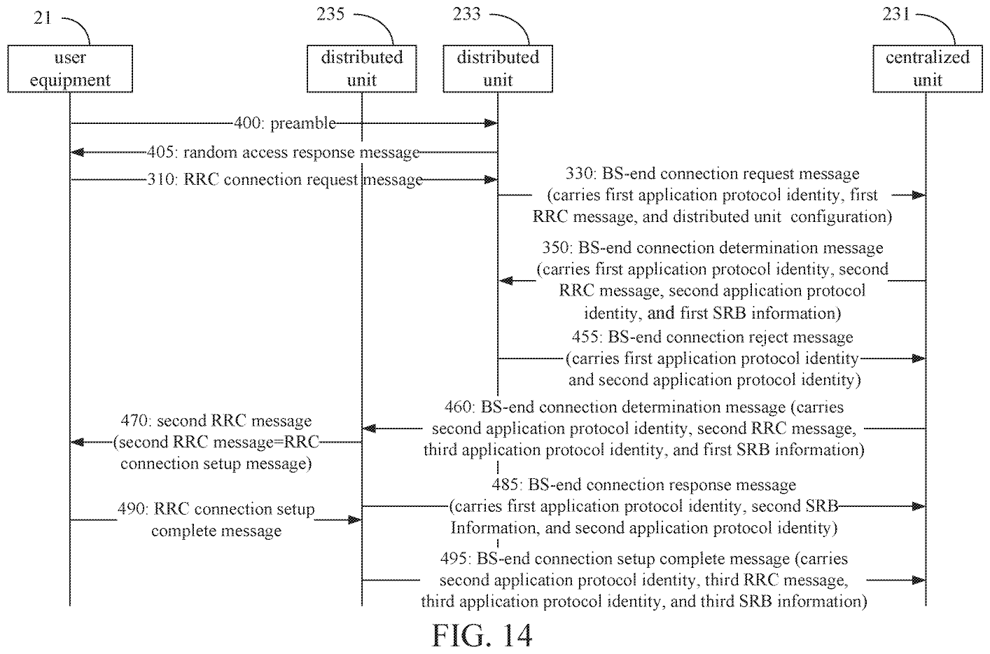

Please refer to FIG. 14, which illustrates a schematic view of the message transmission according to the eleventh embodiment of the present invention. In this embodiment, the user equipment 21 adopts a single beam, which means that the user equipment 21 can only be connected to one distributed unit at each time point, and the other distributed unit can be used as a backup. The following description will focus on the differences between the present embodiment and the aforesaid embodiments.

In this embodiment, the user equipment 21 first transmits a preamble 400 to the distributed unit 233. The transceiving interface 233c of the distributed unit 233 receives the preamble 400, the processor 233a generates a random access response message 405, and then the transceiving interface 233c transmits the random access response message 405 to the user equipment 21.

Next, the user equipment 21 transmits the RRC connection request message 310 to the distributed unit 233, and then the distributed unit 233 transmits the BS-end connection request message 330 to the centralized unit 231. It should be noted that, in this embodiment, the RRC connection request message 310 further carries a notification message which represents that the user equipment 21 has detected the distributed unit 235, and the BS-end connection request message 330 also carries this notification message. In some embodiments, the user equipment 21 may record the information about which other distributed units nearby are detected in a measurement report for the distributed unit 233. For those embodiments, the RRC connection request message 310 may not carry the aforesaid notification message.

After the centralized unit 231 receives the BS-end connection request message 330, it determines to accept the RRC connection request of the user equipment 21. Hence, the BS-end connection determination message 350 generated by the processor 231a carries an RRC connection setup message (i.e., the aforesaid second RRC message carried in the BS-end connection determination message 350 is an RRC connection setup message). Next, the centralized unit 231 transmits the BS-end connection determination message 350 to the distributed unit 233. After the distributed unit 233 receives the BS-end connection determination message 350, it determines that the RRC connection request of the user equipment 21 cannot be accepted (for example, the distributed unit 233 determines that there is not enough radio resources at the time), and therefore the transceiving interface 233b transmits a BS-end connection reject message 455 to the centralized unit 231. The BS-end connection reject message 455 carries the first application protocol identity and the second application protocol identity.

The transceiving interface 231b of the centralized unit 231 receives the BS-end connection reject message 455, and thus learns that the distributed unit 233 does not have enough radio resources to establish an RRC connection with the user equipment 21. Since the centralized unit 231 previously learned from the BS-end connection request message 330 that the user equipment 21 has detected the distributed unit 235, the centralized unit 231 seeks assistance from the distributed unit 235. Specifically, the processor 231a generates another BS-end connection determination message 460, and the transceiving interface 231b transmits the BS-end connection determination message 460 to the distributed unit 235. The BS-end connection determination message 460 carries a second application protocol identity, a third application protocol identity, a second RRC message, and a piece of first SRB information, wherein the second RRC message is an RRC connection setup message. The piece of first SRB information carried in the BS-end connection determination message 460 is configured to indicate which SRB will be used next (for example, to indicate that the SRB0 will be used next) and/or to indicate whether to establish another SRB (for example, to establish the SRB1). In an embodiment, the BS-end connection determination message 460 comprises an RRC container, and the second RRC message may be carried in the information element of a downlink common control channel comprised in the information element of the RRC container.

The transceiving interface 235b of the distributed unit 235 receives the BS-end connection determination message 460. The distributed unit 235 learns that the BS-end connection determination message 460 carries the RRC related message (i.e., carries a second RRC message) after decoding the BS-end connection determination message 460. The processor 235a retrieves the second RRC message from the BS-end connection determination message 460. In an embodiment, the processor 235a retrieves the second RRC message from the information element of the downlink common control channel comprised in the information element of the RRC container comprised in the BS-end connection determination message 460. Thereafter, the transceiving interface 235c transmits the second RRC message 470 to the user equipment 21. After decoding the second RRC message 470, the user equipment 21 learns that the base station 23 accepts the RRC connection request.

In addition, after the distributed unit 235 receives the BS-end connection determination message 460, the processor 235a further generates a BS-end connection response message 485, and the transceiving interface 235b transmits the BS-end connection response message 485 to the centralized unit 231. It should be noted that the BS-end connection response message 485 carries the second application protocol identity, the third application protocol identity, and a piece of second SRB information. The piece of second SRB information carried in the BS-end connection response message 485 is configured to indicate whether a certain SRB is successfully established. It should be noted that the present invention does not limit the order for transmitting the second RRC message 470 and the BS-end connection response message 485 by the distributed unit 235. The distributed unit 235 may first transmit the second RRC message 470 and then transmit the BS-end connection response message 485, may first transmit the BS-end connection response message 485 and then transmits the second RRC message 470, or may simultaneously transmit the second RRC message 470 and the BS-end connection response message 485.

Thereafter, the transceiving interface 231b of the centralized unit 231 receives the BS-end connection response message 485. Because of receiving the BS-end connection response message 485, the centralized unit 231 learns that the distributed unit 235 does receive the BS-end connection determination message 460 transmitted from the centralized unit 231.

As described above, after decoding the second RRC message 470, the user equipment 21 learns that the base station 23 accepts its RRC connection request. Therefore, the user equipment 21 transmits an RRC connection setup complete message 490 to the distributed unit 235 via an uplink dedicated control channel, and the RRC connection setup complete message 490 is received by the transceiving interface 235c of the distributed unit 235 via the uplink dedicated control channel Since the distributed unit 235 receives the RRC connection setup complete message 490 via the uplink dedicated control channel, the distributed unit 235 can learn that the received RRC connection setup complete message 490 is an RRC related message without decoding the RRC connection setup complete message 490.

In response to receiving an RRC related message (i.e., the RRC connection setup complete message 490), the processor 235a generates a BS-end connection setup complete message 398, and the transceiving interface 235b transmits the BS-end connection setup complete message 495 to the centralized unit 231. It should be noted that the BS-end connection setup complete message 495 carries the second application protocol identity, the third application protocol identity, a third RRC message, and a piece of third SRB information. The third RRC message is the RRC connection setup complete message 490 received by the distributed unit 235; in other words, the distributed unit 235 encapsulates the received RRC connection setup complete message 490 into the BS-end connection setup complete message 495. In addition, the piece of third SRB information carried in the BS-end connection setup complete message 495 is configured to indicate which SRB will be used next (e.g., the SRB1 will be used next). In an embodiment, the BS-end connection setup complete message 495 comprises an RRC container, and the third RRC message may be carried in the information element of an uplink dedicated control channel comprised in the information element of the RRC container.

Next, the transceiving interface 231b of the centralized unit 231 receives the BS-end connection setup complete message 495, and the processor 231a further determines that the BS-end connection setup complete message 495 carries an RRC connection setup complete message by decoding the BS-end connection setup complete message 495 (i.e., determines that the BS-end connection setup complete message 495 carries the third RRC message, and determines that the third RRC message is an RRC connection setup complete message after decoding the third RRC message). In an embodiment, the processor 231a retrieves the third RRC message from the information element of the uplink dedicated control channel comprised in the information element of the RRC container comprised in the BS-end connection setup complete message 495 and determines that the third RRC message is an RRC connection setup complete message. Thereby, the centralized unit 231 learns that the RRC connection has been successfully established for the user equipment 21.

According to the above description, in the case where the user equipment 21 can detect a plurality of distributed units of a base station, one of the distributed units can be used as a backup, and therefore the reliability of the base station 23 can be improved.

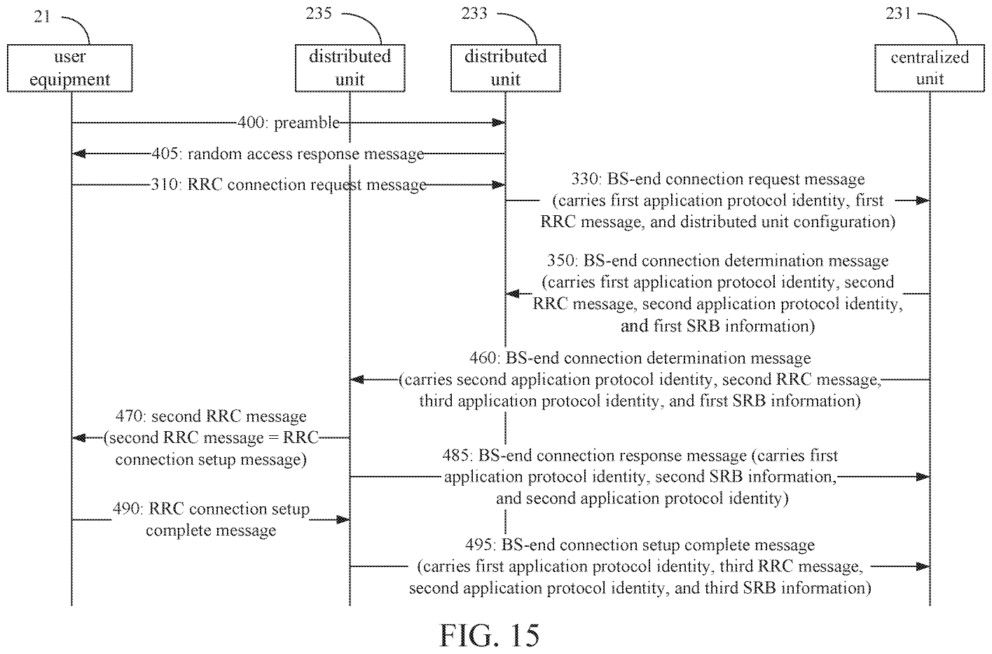

Please refer to FIG. 15, which illustrates a schematic view of the message transmission according to the twelfth embodiment of the present invention. The main difference between the present embodiment and the eleventh embodiment is that the user equipment 21 of the present embodiment uses multiple beams. The following description will focus on the differences between these two embodiments.

In this embodiment, the user equipment 21 first transmits a preamble 400 to the distributed unit 233, and the distributed unit 233 further transmits the random access response message 405 to the user equipment 21. Next, the user equipment 21 transmits the RRC connection request message 310 to the distributed unit 233, and then the distributed unit 233 transmits the BS-end connection request message 330 to the centralized unit 231. Similarly, the RRC connection request message 310 further carries a notification message which represents that the user equipment 21 has detected the distributed unit 235, and the BS-end connection request message 330 also carries the notification message. In some embodiments, the user equipment 21 will record the information about which other distributed units nearby are detected in a measurement report for the distributed unit 233. In an embodiment, the RRC connection request message 310 may not carry the notification message.

After the centralized unit 231 receives the BS-end connection request message 330, it determines to accept the RRC connection request of the user equipment 21. Since the centralized unit 231 learns from the BS-end connection request message 330 that the user equipment 21 has detected the distributed units 233 and 235, the transceiving interface 231b of the centralized unit 231 transmits the BS-end connection determination message 350 to the distributed unit 233 and transmits the BS-end connection determination message 460 to the distributed unit 235. It should be noted that each of the BS-end connection determination message 350 and 460 carries an RRC connection setup message (i.e., the aforesaid second RRC message carried in the BS-end connection determination message 350 and 460 is an RRC connection setup message).

In this embodiment, the distributed unit 233 cannot establish an RRC connection with the user equipment 21, and therefore does not attempt to establish an RRC connection with the user equipment 21 and does not attempt to respond to the centralized unit 231 afterwards. In this embodiment, the distributed unit 235 can establish an RRC connection with the user equipment 21, and the messages transmitted by the user equipment 21, the distributed unit 235, and the centralized unit 231 afterwards are the same as the messages described in the eleventh embodiment (i.e., the second RRC message 470, the BS-end connection response message 485, the RRC connection setup complete message 490, and the BS-end connection setup complete message 495), and therefore they will not be described again.

It should be noted that, in other embodiments, if the distributed unit 235 cannot establish an RRC connection with the user equipment 21, but the distributed unit 233 can establish an RRC connection with the user equipment 21, the process described in the preceding paragraph will be changed to be performed by the user equipment 21, the distributed unit 233, and the centralized unit 231. In addition, if the distributed units 233 and 235 can both establish an RRC connection with the user equipment 21, the aforesaid processes can be performed by both of them to achieve the technical effect of establishing RRC dual connectivity.

According to the above description, in the case where the user equipment 21 uses multiple beams and can detect a plurality of distributed units of a base station, there may be one or more distributed units establishing RRC connections with the user equipment 21 through the operation mechanism of the present embodiment, and thereby improving the probability of establishing an RRC connection and improving the reliability of the connection between the user equipment 21 and the base station 23.

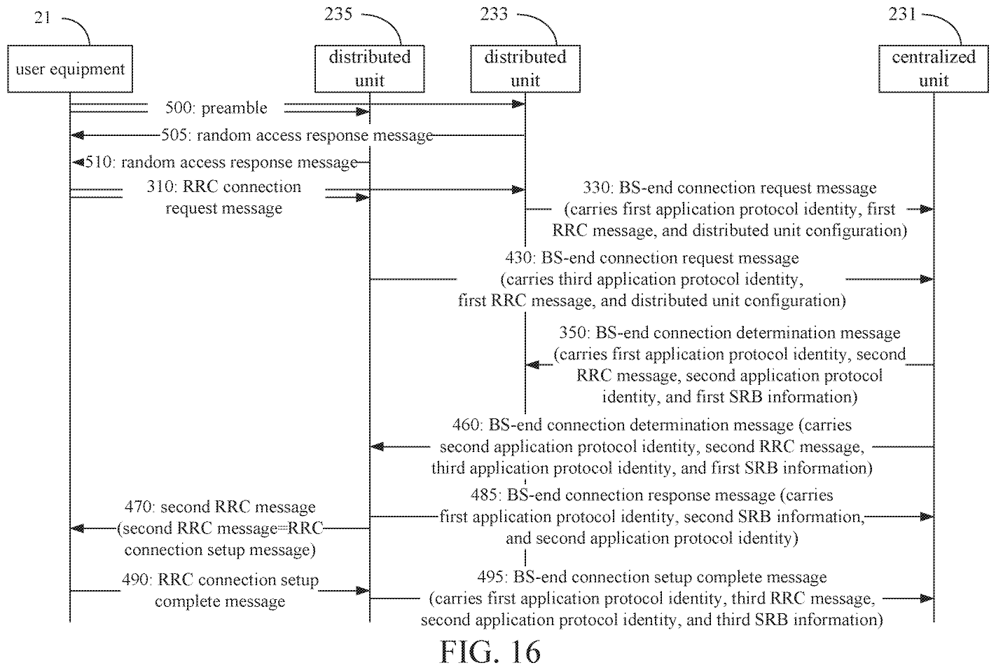

Please refer to FIG. 16, which illustrates a schematic view of the message transmission according to the thirteenth embodiment of the present invention. The present embodiment is similar to the twelfth embodiment, and the main difference between the present embodiment and the twelfth embodiment is that the user equipment 21 of the present embodiment transmits the preamble 500 to a plurality of distributed units 233, 235. The following description will focus on the differences between the two embodiments.

In this embodiment, the user equipment 21 transmits the preamble 500 to both of the distributed units 233 and 235. The distributed units 233, 235 respectively transmit the random access response messages 505 and 510 to the user equipment 21. Then, the user equipment 21 also transmits the RRC connection request message 310 to the distributed units 233 and 235 via the uplink common control channel The distributed units 233 and 235 respectively transmit the BS-end connection request messages 330 and 430 to centralized units 231. As described above, the BS-end connection request message 330 carries a first application protocol identity and a first RRC message, wherein the first RRC message is the RRC connection request message 310 received by the distributed unit 233. Similarly, the BS-end connection request message 430 carries a third application protocol identity and a first RRC message, wherein the first RRC message is the RRC connection request message 310 received by distributed unit 235. In an embodiment, the BS-end connection request message 430 comprises an RRC container, and the first RRC message may be carried by the information element of the uplink common control channel comprised in the information element of the RRC container.

In response to the BS-end connection request message 330, the centralized unit 231 transmits the BS-end connection determination message 350 to the distributed unit 233. In addition, in response to the BS-end connection request message 430, the centralized unit 231 transmits the BS-end connection determination message 460 to the distributed unit 235.

Subsequently, each of the distributed units 233 and 235 determines whether an RRC connection can be established for the user equipment 21. In this embodiment, the distributed unit 233 cannot establish an RRC connection with the user equipment 21, and therefore does not attempt to establish an RRC connection with the user equipment 21 and does not attempt to respond to the centralized unit 231 afterwards. In this embodiment, the distributed unit 235 can establish an RRC connection with the user equipment 21, and the messages transmitted by the user equipment 21, the distributed unit 235, and the centralized unit 231 afterwards are the same as the messages described in the twelfth embodiment (i.e., the second RRC message 470, the BS-end connection response message 485, the RRC connection setup complete message 490, and the BS-end connection setup complete message 495), and therefore they will not be described again.

It should be noted that, in other embodiments, if the distributed unit 235 cannot establish an RRC connection with the user equipment 21, but the distributed unit 233 can establish an RRC connection with the user equipment 21, the process described in the preceding paragraph will be changed to be performed by the user equipment 21, the distributed unit 233, and the centralized unit 231. In addition, if the distributed units 233 and 235 can both establish an RRC connection with the user equipment 21, the aforesaid processes can be performed by both of them to achieve the technical effect of establishing RRC dual connectivity.

According to the above description, in the case where the user equipment 21 uses multiple beams and can detect a plurality of distributed units of a base station, there may be one or more distributed units establishing RRC connections with the user equipment 21 through the operation mechanism of the present embodiment, and thereby improving the probability of establishing an RRC connection and improving the reliability of the connection between the user equipment 21 and the base station 23.

In each of the above embodiments, the internal operations of the base stations 23 and 33 are described by the example of the user equipment 21 sending the RRC connection request message 310. According to the above description, a person having ordinary skills in the art should understand how the internal operations be performed by the base stations 23 and 33 for responding user equipment 21 when the user equipment 21 sends other RRC related requests (for example, a re-establishing RRC connection request).

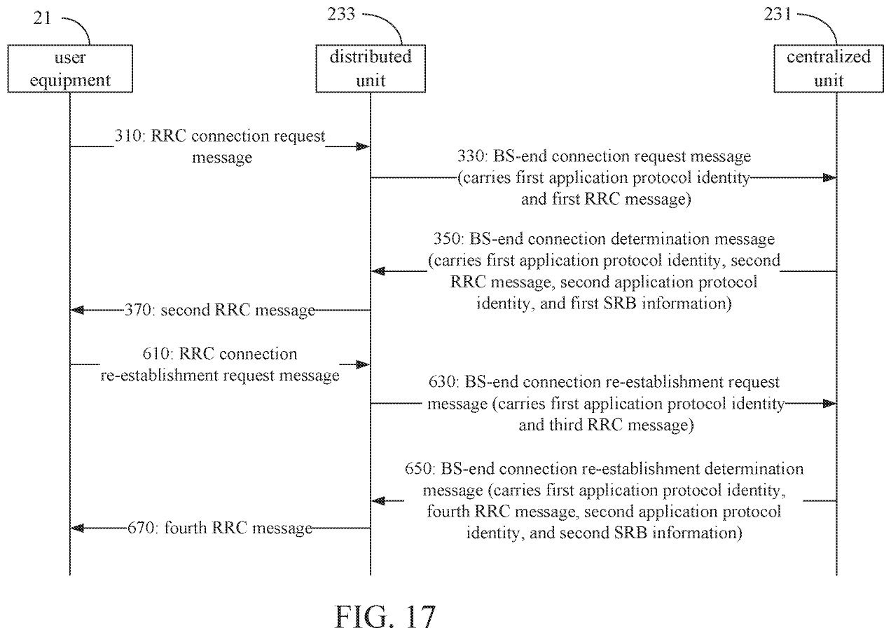

Please refer to FIG. 17, which illustrates a schematic view of the message transmission according to the fourteenth embodiment of the present invention. This embodiment is an extension of the first embodiment. It is assumed that the user equipment 21 loses connection with the base station 23 at a certain time, and thus it is required to re-establish the RRC connection.

When the RRC connection is required to be re-established, the user equipment 21 transmits an RRC connection re-establishment request message 610 via an uplink common control channel, and the transceiving interface 233c of the distributed unit 233 receives the RRC connection re-establishment request message 610 from the user equipment 21 via the uplink common control channel. Since the distributed unit 233 receives the RRC connection re-establishment request message 610 via the uplink common control channel, the distributed unit 233 can learn that the received RRC connection re-establishment request message 610 is an RRC related message without decoding the RRC connection re-establishment request message 610.

In response to receiving an RRC related message (i.e., the RRC connection re-establishment request message 610), the processor 233a of the distributed unit 233 generates a BS-end connection re-establishment request message 630, and the transceiving interface 233b further transmits the BS-end connection re-establishment request message 630 to the centralized unit 231. It should be noted that the BS-end connection re-establishment request message 630 carries a first application protocol identity and a third RRC message. The third RRC message is an RRC connection re-establishment request message 610 received by the distributed unit 233; in other words, the distributed unit 233 encapsulates the received RRC connection re-establishment request message 610 into the BS-end connection re-establishment request message 630. In an embodiment, the BS-end connection re-establishment request message 630 comprises an RRC container, and the third RRC message may be carried in the information element of the uplink common control channel comprised in the information element of the RRC container.

Next, the transceiving interface 231b of the centralized unit 231 receives the BS-end connection re-establishment request message 630. The processor 231a determines that the BS-end connection re-establishment request message 630 carries an RRC connection re-establishment request message by decoding the BS-end connection re-establishment request message 630 (i.e., determines that the BS-end connection re-establishment request message 630 carries the third RRC message, and determines that the third RRC message is an RRC connection re-establishment request message by decoding the third RRC message). In an embodiment, the processor 231a retrieves the third RRC message from the information element of the uplink common control channel comprised in the information element of the RRC container comprised in the BS-end connection re-establishment request message 630 and determines that the third RRC message is an RRC connection re-establishment request message.

In response to receiving the RRC connection re-establishment request message, the processor 231a of the centralized unit 231 generates a BS-end connection re-establishment determination message 650. The transceiving interface 231b then transmits the BS-end connection re-establishment determination message 650 to the distributed unit 233. It should be noted that the BS-end connection re-establishment determination message 650 carries a first application protocol identity, a second application protocol identity, a fourth RRC message, and a piece of second SRB information. Depending on different situations (for example, whether the base station 23 has sufficient radio resources and the load situation of the core network), the fourth RRC message may be an RRC connection re-establishment message or an RRC connection re-establishment reject message. In addition, the piece of second SRB information carried in the BS-end connection re-establishment determination message 650 is configured to indicate which SRB will be used next (for example, to indicate that the SRB0 will be used next) and/or to indicate whether to establish another SRB (for example, to establish the SRB1). In an embodiment, the BS-end connection re-establishment determination message 650 comprises an RRC container, and the fourth RRC message may be carried in the information element of the downlink common control channel comprised in the information element of the RRC container.

Thereafter, the transceiving interface 233b of the distributed unit 233 receives the BS-end connection re-establishment determination message 650 from the centralized unit 231. The distributed unit 233 learns that the received BS-end connection re-establishment determination message 650 carries RRC related message after decoding the BS-end connection re-establishment determination message 650 (i.e., carries a fourth RRC message). The processor 233a retrieves the fourth RRC message from the BS-end connection re-establishment determination message 650. In an embodiment, the processor 233a retrieves the fourth RRC message from the information element from the information element of the downlink common control channel comprised in the information element of the RRC container comprised in the BS-end connection re-establishment determination message 650. Thereafter, the transceiving interface 233c transmits the fourth RRC message 670 to the user equipment 21 via the downlink common control channel After decoding the fourth RRC message 670, the user equipment 21 learns that the base station 23 accepts or rejects its RRC connection re-establishment request.

Through the aforesaid process, the centralized unit 231 and the distributed unit 233 of the base station 23 can respond to the RRC connection re-established request by the user equipment 21 through a 2-way handshaking process. Similarly, the above second to thirteenth embodiments may also be extended, and the RRC connection re-establishment request may be implemented by performing the same operation in each of the embodiments.

According to the above embodiments, the distributed unit and the centralized unit provided by the present invention may be used together as a base station. After receiving the RRC connection request message transmitted by the user equipment, the distributed unit does not need to decode the RRC connection request message. Instead, the distributed unit encapsulates the RRC connection request message into a BS-end connection request message, and then transmit the BS-end request message to the centralized unit. After receiving the BS-end connection request message, the centralized unit decodes it and thus learns that the user equipment has sent the RRC connection request (by sending the RRC connection request message). In response to the RRC connection request of the user equipment, the centralized unit further encapsulates an RRC message (which may be an RRC connection setup message or an RRC connection reject message) and a piece of SRB information into a BS-end connection determination message and transmits the BS-end connection determination message to the distributed unit. After receiving the BS-end connection determination message, the distributed unit does not need to decode the RRC message carried in the BS-end connection determination message, but transfer the RRC message to the user equipment instead. Through the aforesaid process, although the communication protocol stack performed by the distributed unit does not comprise the RRC layer and cannot decode the RRC connection related message, the distributed unit can still respond to the RRC connection request of the user equipment by cooperating with the centralized unit. Therefore, the distributed unit and the centralized unit provided by the present invention have solved the aforesaid technical problems faced by the 5G mobile communication system.

The above disclosure is only intended to illustrate some of the embodiments of the present invention but not intended to limit the scope of protection and scope of the present invention. Any arrangements that can be retouched, replaced, altered, and equally arranged by a person having ordinary skill in the art based on the above disclosures and suggestions are within the scope of the present invention, and the scope of protection of the invention is defined by the following Claims.

What is claimed is:

1. A distributed unit of a base station, wherein the base station comprises the distributed unit and a centralized unit, and wherein the distributed unit comprises:
a first transceiving interface;
a second transceiving interface, being configured to receive a Radio Resource Control (RRC) connection request message from a user equipment; and
a processor, being electrically connected to the first transceiving interface and the second transceiving interface, and being configured to generate a base station end (BS-end) connection request message in response to the RRC connection request message, wherein the BS-end connection request message carries a first application protocol identity and a first RRC message, the first application protocol identity is configured to uniquely identify the user equipment over the first transceiving interface within the distributed unit, and the first RRC message is the RRC connection request message;
wherein the first transceiving interface further transmits the BS-end connection request message to the centralized unit and receives a BS-end connection determination message from the centralized unit, the BS-end connection determination message carries the first application protocol identity, a second application protocol identity, a second RRC message, and a piece of first Signaling Radio Bearer (SRB) information, and the second application protocol identity is configured to uniquely identify the user equipment over the first transceiving interface within the centralized unit; and
wherein the processor further retrieves the second RRC message from the BS-end connection determination message, and the second transceiving interface further transmits the second RRC message to the user equipment.

2. The distributed unit of claim 1, wherein the BS-end connection request message further carries a distributed unit configuration, and the second RRC message is an RRC connection setup message;
wherein the second transceiving interface further receives an RRC connection setup complete message from the user equipment, and the processor further generates a BS-end connection setup complete message in response to the RRC connection setup complete message, wherein the BS-end connection setup complete message carries the first application protocol identity, the second application protocol identity, a third RRC message, and a piece of second SRB information, and the third RRC message is the RRC connection setup complete message; and
wherein the first transceiving interface further transmits the BS-end connection setup complete message to the centralized unit.

3. The distributed unit of claim 1, wherein the second RRC message is an RRC connection reject message.

4. The distributed unit of claim 1, wherein the BS-end connection request message further carries a distributed unit configuration, and the second RRC message is an RRC connection reject message.

5. The distributed unit of claim 4, wherein the processor further generates a BS-end connection reject complete message, the BS-end connection reject complete message carries the first application protocol identity, the second application protocol identity, and a piece of second SRB information, and the first transceiving interface further transmits the BS-end connection reject complete message to the centralized unit.

6. The distributed unit of claim 1, wherein the first transceiving interface further receives a BS-end connection setup message from the centralized unit, the BS-end connection setup message carries the first application protocol identity, the second application protocol identity, a third RRC message, and a piece of second SRB information;
wherein the processor further determines that the connection cannot be setup after the first transceiving interface receives the BS-end connection setup message, the processor further generates a BS-end connection reject message, the BS-end connection reject message carries the first application protocol identity and the second application protocol identity, and the first transceiving interface further transmits the BS-end connection reject message to the centralized unit; and
wherein the first transceiving interface receives the BS-end connection determination message after transmitting the BS-end connection reject message, and the second RRC message is an RRC connection reject message.

7. The distributed unit of claim 6, wherein the BS-end connection reject message further carries a piece of third SRB information.

8. The distributed unit of claim 1, wherein the BS-end connection request message further carries a distributed unit configuration, and the second RRC message carried by the BS-end connection determination message is an RRC connection setup message;
wherein the first transceiving interface further transmits a BS-end connection response message to the centralized unit, and the BS-end connection response message carries the first application protocol identity, the second application protocol identity, and a piece of second SRB information;
wherein the second transceiving interface further receives an RRC connection setup complete message from the user equipment, and the processor further generates a BS-end connection setup complete message in response to the RRC connection setup complete message, wherein the BS-end connection setup complete message carries the first application protocol identity, the second application protocol identity, a third RRC message, and a piece of third SRB information, and the third RRC message is the RRC connection setup complete message; and
wherein the first transceiving interface further transmits the BS-end connection setup complete message to the centralized unit.

9. The distributed unit of claim 1, wherein the second transceiving interface further receives an RRC connection re-establishment request message from the user equipment, the processor further generates a BS-end connection re-establishment request message in response to the RRC connection re-establishment request message, the BS-end connection re-establishment request message carries the first application protocol identity and a third RRC message, and the third RRC message is the RRC connection re-establishment request message;
wherein the first transceiving interface further transmits the BS-end connection re-establishment request message to the centralized unit and further receives a BS-end connection re-establishment determination message from the centralized unit, wherein the BS-end connection re-establishment determination message carries the first application protocol identity, the second application protocol identity, a fourth RRC message, and a piece of second SRB information; and
wherein the processor further retrieves the fourth RRC message from the BS-end connection re-establishment determination message, and the second transceiving interface further transmits the fourth RRC message to the user equipment.

10. The distributed unit of claim 1, wherein the first transceiving interface further transmits one of an acknowledgement and a negative acknowledgement to the centralized unit.

11. A centralized unit of a base station, wherein the base station comprises the centralized unit and a first distributed unit, and wherein the centralized unit comprises:
a transceiving interface, being configured to receive a first BS-end connection request message, wherein the first BS-end connection request message carries a first application protocol identity and a first RRC message, and the first application protocol identity is configured to uniquely identify the user equipment over the transceiving interface within the first distributed unit; and
a processor, being electrically connected to the transceiving interface, and being configured to determine that the first RRC message is an RRC connection request message by decoding the first BS-end connection request message and generate a first BS-end connection determination message in response to the RRC connection request message, wherein the first BS-end connection determination message carries the first application protocol identity, a second application protocol identity, a second RRC message, and a piece of first SRB information, and the second application protocol identity is configured to uniquely identify the user equipment over the transceiving interface within the centralized unit;
wherein the transceiving interface further transmits the first BS-end connection determination message to the first distributed unit.

12. The centralized unit of claim 11, wherein the first BS-end connection request message further carries a distributed unit configuration, and the second RRC message is an
wherein the transceiving interface further receives a BS-end connection setup complete message from the first distributed unit, the BS-end connection setup complete message carries the first application protocol identity, the second application protocol identity, a third RRC message, and a piece of second SRB information, and the third RRC message is an RRC connection setup complete message

13. The centralized unit of claim 11, wherein the second RRC message is an RRC connection reject message.

14. The centralized unit of claim 11, wherein the first BS-end connection request message further carries a distributed unit configuration, and the second RRC message is an RRC connection reject message.

15. The centralized unit of claim 14, wherein the transceiving interface further receives a BS-end connection reject complete message, and the BS-end connection reject complete message carries the first application protocol identity, the second application protocol identity, and a piece of second SRB information.

16. The centralized unit of claim 11, wherein the processor further generates a BS-end connection setup message, the BS-end connection setup message carries the first application protocol identity, the second application protocol identity, a third RRC message, and a piece of second SRB information, and the transceiving interface further transmits the BS-end connection setup message to the first distributed unit;
wherein the transceiving interface further receives a BS-end connection reject message from the first distributed unit, and the BS-end connection reject message carries the first application protocol identity and the second application protocol identity; and
wherein the second RRC message is an RRC connection reject message.

17. The centralized unit of claim 16, wherein the BS-end connection reject message further carries a piece of third SRB information.

18. The centralized unit of claim 11, wherein the first BS-end connection request message further carries a distributed unit configuration, and the second RRC message is an RRC connection setup message;
wherein the transceiving interface further receives a BS-end connection response message from the first distributed unit, and the BS-end connection response message further carries the first application protocol identity, the second application protocol identity, and a piece of second SRB information; and
wherein the transceiving interface further receives a BS-end connection setup complete message from the first distributed unit, the BS-end connection setup complete message carries the first application protocol identity, the second application protocol identity, a third RRC message, and a piece of third SRB information, and the third RRC message is the RRC connection setup complete message.

19. The centralized unit of claim 11, wherein the transceiving interface further receives a BS-end connection re-establishment request message from the first distributed unit, and the BS-end connection re-establishment request message carries the first application protocol identity and a third RRC message; and
wherein the processor further determines that the third RRC message is an RRC connection re-establishment request message by decoding the BS-end connection re-establishment request message and generates a BS-end connection re-establishment determination message in response to the RRC connection re-establishment request message, the BS-end connection re-establishment determination message carries the first application protocol identity, the second application protocol identity, a fourth RRC message, and a piece of second SRB information, and the transceiving interface further transmits the BS-end connection re-establishment determination message to the first distributed unit.

20. The centralized unit of claim 11, wherein the transceiving interface further receives one of an acknowledgement and a negative acknowledgement from the first distributed unit.

21. The centralized unit of claim 11, wherein the first BS-end connection request message further carries a distributed unit configuration, and the second RRC message is an RRC connection setup message;
wherein the processor further starts a timer upon the transceiving interface receiving the first BS-end connection request message, and the transceiving interface further retransmits the first BS-end connection determination message to the first distributed unit after the timer has started for a preset length of time; and
wherein the transceiving interface further receives a BS-end connection setup complete message from the first distributed unit, the BS-end connection setup complete message carries the first application protocol identity, the second application protocol identity, a third RRC message, and a piece of second SRB information, and the third RRC message is an RRC connection setup complete message.

22. The centralized unit of claim 11, wherein the first BS-end connection request message further carries a distributed unit configuration, and the second RRC message is an RRC connection setup message;
wherein the processor further starts a timer upon the transceiving interface receiving the first BS-end connection request message, the transceiving interface further receives a negative acknowledgement within a preset length of time after the timer is started, the transceiving interface further transmits the first BS-end connection determination message to the first distributed unit after receiving the negative acknowledgement; and
wherein the transceiving interface further receives a BS-end connection setup complete message from the first distributed unit, the BS-end connection setup complete message carries the first application protocol identity, the second application protocol identity, a third RRC message, and a piece of second SRB information, and the third RRC message is an RRC connection setup complete message

23. The centralized unit of claim 11, wherein the second RRC message is an RRC connection setup message, the transceiving interface further receives a BS-end connection reject message from the first distributed unit, and the BS-end connection reject message carries the first application protocol identity and the second application protocol identity;
wherein the base station further comprises a second distributed unit, the processor further generates a second BS-end connection determination message after the transceiving interface receiving the BS-end connection reject message, the second BS-end connection determination message carries the second application protocol identity, a third application protocol identity, the second RRC message, and the piece of first SRB information, the third application protocol identity is configured to uniquely identify the user equipment over the transceiving interface within the second distributed unit, and the transceiving interface further transmits the second BS-end connection determination message to the second distributed unit;
wherein the transceiving interface further receives a BS-end connection response message from the second distributed unit, and the BS-end connection response message carries the second application protocol identity, the third application protocol identity, and a piece of second SRB information; and
wherein the transceiving interface further receives a BS-end connection setup complete message from the second distributed unit, the BS-end connection setup complete message carries the second application protocol identity, the third application protocol identity, a third RRC message, and a piece of third SRB information, and the third RRC message is the RRC connection setup complete message.

24. The centralized unit of claim 11, wherein the second RRC message is an RRC connection setup message, the base station further comprises a second distributed unit, the processor further generates a second BS-end connection determination message, the second BS-end connection determination message carries the second application protocol identity, a third application protocol identity, the second RRC message, and the piece of first SRB information, the third application protocol identity is configured to uniquely identify the user equipment over the transceiving interface within the second distributed unit, and the transceiving interface further transmits the second BS-end connection determination message to the second distributed unit;
wherein the transceiving interface further receives a BS-end connection response message from the second distributed unit, and the BS-end connection response message carries the second application protocol identity, the third application protocol identity, and a piece of second SRB information; and
wherein the transceiving interface further receives a BS-end connection setup complete message from the second distributed unit, the BS-end connection setup complete message carries the second application protocol identity, the third application protocol identity, a third RRC message, and a piece of third SRB information, and the third RRC message is the RRC connection setup complete message.

25. The centralized unit of claim 24, wherein the transceiving interface further receives a second BS-end connection request message from the second distributed unit, and the second BS-end connection request message carries the third application protocol identity and the first RRC message.
